(19) United States
(12) Patent Application Publication
(10) Pub. No.: US 2010/0317819 A1
(43) Pub. Date: Dec. 16, 2010

(54) SURFACE-MODIFIED NANOPARTICLES COMPRISING A CATIONIC COLORANT FOR USE IN COLOR FILTERS

(75) Inventors: Gerardus De Keyzer, Riehen (CH); Bernd Lamatsch, Riehen (CH); Andreas Muehlebach, Frick (CH); Francois Rime, Delemont (CH); Gregor Schmitt, Heerlen (NL)

Correspondence Address: BASF Corporation;Patent Department, 500 White Plains Road, P.O. Box 2005, Tarrytown, NY, 10591, US

(73) Assignee: CIBA CORPORATION, Tarrytown, NY (US)

(21) Appl. No.: 12/528,500

(22) PCT Filed: Feb. 20, 2008
(86) PCT No.: PCT/EP08/52026

§ 371 Date: Aug. 25, 2009

(30) Foreign Application Priority Data
Mar. 5, 2007 (EP) 07103497.9

(51) Int. Cl. C08G 77/04; C07F 7/10

(52) U.S. Cl. 528/33; 556/413; 556/418; 977/773

(57) ABSTRACT

Color filter comprising a surface-modified nanoparticle wherein a cationic colorant is covalently attached to the surface of said nanoparticle, a polymerizable mixture for making color filters, a surface-modified nanoparticle and its use.

The present invention relates to color filters comprising surface-modified nanoparticles, a polymerizable mixture for making color filters, to surface-modified nanoparticles and their use for making color filters.

C.I. Pigment Blue 1 (N-[4-[[4-(diethylamino)phenyl][4-(ethylamino)-1-naphthalenyl]methylene]-2,5-cyclohexadiene-1-ylidene]-N-ethyl-ethaneammonium, molybdate tungstate phosphate; or phospho-tungsto-molybdic acid salt; Ultra Blue B; Victoria Pure Blue B; Fast blue lake BO) has perfect optical properties for use in color filter applications. However, the thermal and light stability of this pigment and many others is far too low for the use in color filters.

It is known from the literature (see for example Nakazumi et al. (1995) Journal of the Society of Dyers and Colorists, 111, 150-153) that a dye incorporated in silica becomes more stable. This is partly explained by the fact that due to the rigid structure of the silica the dye cannot move or bend and therefore it is less reactive. These dyes often show a small shift and a broadening of its absorption spectra. Nakazumi et al. (1995) exclusively use certain triaryl methane dyes as disperse dyes in silica (made by the sol-gel method).

WO 2006/125736 A1 discloses functionalized nanoparticles of SiO₂, Al₂O₃ or mixed particles, which comprise via a linking group a covalently bound radical of a cationic dye, a phthalocyanine dye or a fluorescent dye on the surface, and their use for coloring organic material, in particular synthetic polymers or coatings.

Color filters are generally produced by forming a fine colored pattern on a transparent substrate such as glass or a reflective substrate such as silicon and metals with three coloring compositions of red, green and blue colors. Dyes have heretofore been often used in these coloring compositions. However, pigments having excellent light fastness and heat fastness, particularly, organic pigments have come to be often used in place of the dyes because the dyes have limits in light fastness and heat fastness though they are excellent in color characteristics.

There is a continuing need for color filter materials having improved properties, especially improved thermal, light and/or physical stability.

It has been found that surface-modified nanoparticles, wherein a cationic colorant, in particularly triarylcarbonium dyestuffs and pigments, is covalently attached to the surface of said nanoparticle are especially useful for color filters.

Therefore, a first embodiment of the instant invention relates to a color filter comprising a surface-modified nanoparticle wherein a cationic colorant is covalently attached to the surface of said nanoparticle (=colored nanoparticles).

Preferred cationic colorants include, but are not limited to,
(i) di(tri)-aryl(hetero)-dyestuffs, preferably selected from the group consisting of triarylmethane, heteroaryldiarylmethane, diheteroarylarylmethane, xanthene and thioxanthene dyes ((thio)xanthylium dyes), and/or
(ii) tri-aryl(hetero)-carbonium pigments.

Special preference is given to triarylmethane dyes selected from the group consisting of Color Index names Acid Blue 1, Acid Blue 7, Acid Blue 9, Acid Blue 22, Acid Blue 93, Acid Blue 147, Acid Green 5, Acid Violet 19, Acid Violet 49, Basic Blue 7, Basic Blue 20, Basic Blue 26, Basic Green 4, Basic Red 9, Basic Violet 2, Basic Violet 3, Basic Violet 4, Basic Violet 14, Mordant Blue 1, Mordant Blue 3, Mordant Violet 39, Solvent Blue 3, Solvent Red 41, and Solvent Violet 9 as the cationic colorant of the surface-modified nanoparticle according to the present invention.

Particularly preferred are surface-modified nanoparticles wherein the cationic colorant is derived from:

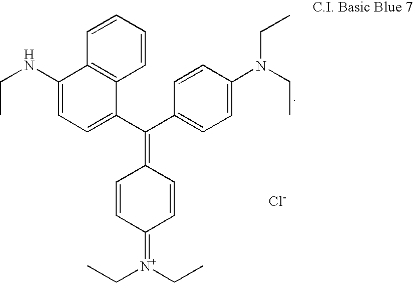

Other suitable cationic colorants of the surface-modified nanoparticle according to the present invention are triarylcarbonium pigments, preferably selected from the group consisting of Color Index names P. Blue 18, P. Blue 19, P. Blue 56, P. Blue 61, P. Violett 3, P. Violett 27, P. Violett 39, P. Blue 1, P. Blue 2, P. Blue 9, P. Blue 10, P. Blue 14, P. Blue 62, P. Green 1, P. Green 4, P. Green 45, P. Red 81, P. Red 81:1, P. Red 81:x, P. Red 81:y, P. Red 81:2, P. Red 81:3, P. Red 81:4, P. Red 169, P. Violett 1, P. Violett 1:x, and P. Violett 2.

A preferred embodiment of the present invention relates to a color filter comprising a colored nanoparticle wherein also a light stabilizer, preferably a UV absorber, is covalently attached to the surface of said nanoparticle.

The light stabilizer mentioned hereinbefore is preferably selected from the group consisting of hindered amine light stabilizer (HALS), benzophenones, benzotriazoles, and hydroxyphenyl triazines.

For example, an UV absorber moiety selected from the group consisting of 2-[2-hydroxy-3,5-di-(alpha,alpha-dimethylbenzyl)phenyl]-2H-benzotriazole, 2-(2-hydroxy-3,5-di-tert-amylphenyl)-2H-benzotriazole, 2-[2-hydroxy-3-tert-butyl-5-(omega-hydroxy-octa(ethyleneoxy)carbonyl)ethylphenyl]-2H-benzotriazole, 2-[2-hydroxy-3-tert-butyl-5-(2-octyloxycarbonylethyl)phenyl]-2H-benzotriazole, 4,4′-dioctyloxyoxanilide, 2,2′-dioctyloxy-5,5′-di-tert-butyloxanilide, 2,2′-didodecyloxy-5,5′-di-tert-butyloxanilide, 2-ethoxy-2′-ethyloxanilide, 2,6-bis(2,4-dimethylphenyl)-4-(2-hydroxy-4-octyloxyphenyl-s-triazine, 2,6-bis(2,4-dimethylphenyl)-4-(2,4-dihydroxyphenyl)-s-triazine, 2,4-bis(2,4-dihydroxyphenyl)-6-(4-chlorophenyl)-s-triazine, 2,6-bis(2,4-dimethylphenyl)-4-[2-hydroxy-4-(2-hydroxy-3-dodecyloxypropanoxy)phenyl]s-triazine, and 2,2′-dihydroxy-4,4′-dimethoxybenzophenone can be used as said light stabilizer.

Another preferred embodiment of the instant invention relates to a color filter comprising a colored nanoparticle wherein a dispersant is covalently attached to the surface of said nanoparticle, either in addition to a light stabilizer or without.

As to the dispersant utilized herein, it may comprise one or more anionic or cationic dispersants or a blend thereof.

Examples of anionic dispersants are water-soluble salts, particularly alkali metal salts of sulfate esters or sulfonates containing higher aliphatic hydrocarbon radicals of 8 or more carbon atoms (e.g. 8-22 carbon atoms), such as sodium or potassium sulfates of higher alcohols (e.g. sulfates of alkanols such as coco alcohol or sulfates of other higher alcohols such as the higher alkyl phenolethylene oxide ether sulfates or the higher fatty acid monoglyceride sulfates or the ethoxylated higher fatty alcohol sulfates), sodium or potassium salts of higher sulfonic acids (e.g. of C₈-C₂₂alkylbenzene sulfonic acids such as pentadecyl benzene sulfonic acid, or of isothionate esters of higher fatty acids, e.g. with 8 to 22 carbon atoms, such as coconut oil fatty acids) or alkali metal salts of (hetero)cyclic thiols, such as 2-mercapto-1-methylimidazolide. The sodium alkyl aryl sulfonates are preferred.

Organic phosphonates are also suitable as dispersants. Preferred are phosphoric acid esters and salts thereof of the general formula (I),

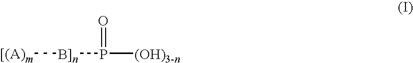

wherein

A is a monohydroxyl residue;

B is a mono-, di-, tri- or polyhydroxy di-, tri- or multi-carboxylic acid residue which is linked via the hydroxy group to the phosphoric acid and via one of the carboxylic acid groups to the monohydroxyl residue [A], the remaining carboxylic acid group(s) is/are free or is/are esterified with a further monohydroxyl residue [A], resulting in branched esters;

n is 1 or 2;

m is 1, 2, 3 or 4.

With regard to [B] it is preferred that either at least one free carboxylic acid group is present or that at least one branching center results by esterifying the free carboxylic acid. If a tri- or multi-carboxylic acid is chosen, two or more free carboxylic acid groups are present. It is possible that the free carboxylic acid groups remain free, are fully esterified resulting in branched compounds or are partly esterified resulting in branched compounds having a free carboxylic acid group. The free carboxylic groups can be transformed into a salt in all cases.

The mono-, di-, tri- or polyhydroxy di-, tri- or multi-carboxylic acid [B] to be used may, for example, be tartaric acid, malic acid, citromalic acid (2-methylmalic acid), 3-hydroxy-3-methylglutaric acid, 5-hydroxyisophthalic acid, ascorbic acid or citric acid, preferably malic acid (hydroxybutane dicarboxylic acid) or citric acid.

A multi-carboxylic acid is any acid that comprises more than three carboxylic acid groups, e.g. hydroxy benzene-1,2,4,5-tetracarboxylic acid.

The monohydroxyl residue [A] may comprise a polyether chain, a polyester chain or a mixed polyether-polyester chain, whereby the respective groups can be arranged in blocks or randomly.

Preferably [A] comprises a polyC₂-C₄alkylene glycolmonoether and/or a polyC₂-C₄alkylene glycol monoester of a carboxylic acid.

Suitable polyC₂-C₄alkylene glycolmonoethers are C₁-C₂₀alkylethers, preferably methylethers such as polyethylene glycolmonomethylether (MePEG) or polypropylene glycolmonomethylether (MePPG), butylethers such as polypropylene monobutylether (BuPPG), alkylphenol ethers (APE), C₁₂-C₂₀ fatty alcohol ethers or C₁₀-C₁₅ oxoalcohol ethers.

PolyC₂-C₄alkylene glycol esters of carboxylic acids are, for example, polyC₂-C₄alkylene glycol monolaurate, polyC₂-C₄alkylene glycol monostearate, polyC₂-C₄alkylene glycol monooleate, and polyC₂-C₄alkylene glycol benzoate.

The polyC₂-C₄alkylene glycolmonoether and/or the polyC₂-C₄alkylene glycol monoester may be esterified with [B] or may be linked to [B] via polyester units derived from a hydroxy-carboxylic acid or a lactone thereof [HA] and/or via units derived from a dicarboxylic acid [AA] which is linked to a diol with a C₂-C₄alkylene oxide [AO] structure.

Thus, the following monohydroxyl compounds [A] may be obtained

C₁-C₂₀alkyl-(AO)ₓ—OH or Acyl-(AO)ₓ—OH

C₁-C₂₀alkyl-(AO)ₓ—(HA)_{y}-OH or Acyl-(AO)ₓ—(HA)_{y}-OH

C₁-C₂₀alkyl-(AO)ₓ-(AA-AO)_{y}—OH or Acyl-(AO)ₓ-(AA-AO)_{y}—OH,

wherein

C₁-C₂₀alkyl is a straight chain or, if possible, a branched hydrocarbon residue,

acyl is an aromatic carboxylic acid residue such as, for example, derived from benzoic acid or a saturated or unsaturated fatty acid residue such as, for example, derived from lauric acid, myristic acid, stearic acid, arachic acid, oleic acid, linoleic acid and the like,

AO is a divalent polyC₂-C₄alkyleneglycol residue such as, for example, derived from polyethylene glycol (PEG), polypropylene glycol (PPG), polybutylene glycol, including a block copolymer of ethylene oxide and propylene oxide,

HA is a divalent residue derived from a hydroxycarboxylic acid or a lactone thereof such as, for example, lactic acid, glycolic acid, 6-hydroxyhexanoic acid, 12-hydroxystearic acid, 12-hydroxydodecanoic acid, 5-hydroxydodecanoic acid, 5-hydroxydecanoic acid, 4-hydroxydecanoic acid, or lactones such as β-propiolactone, γ-butyrolactone, δ-valerolactone or ε-caprolactone, including a block copolymer such as, for example, of ε-caprolactone/δ-valerolactone,

AA is a divalent residue derived from a dicarboxylic acid such as, for example, succinic acid, maleic acid, malonic acid, glutaric acid, adipic acid, phthalic acid, sebacic acid, oxalic acid, diglycolic acid and acid anhydrides thereof,

x is 1 to 250, preferably 2 to 50, more preferably 5, 6, 7, 8, 9, 10, 11, 12, 13, 14, 15,

y is 1 to 250, preferably 2 to 50, more preferably 2, 3, 4, 5, 6, 7, 8, 9, 10, 11, 12, 13, 14, 15.

It is also possible to start one end of the polyester unit HA with a monoalcohol residue MO suitably with 4 to 30, preferably with 4 to 20 carbon atoms, such as derived from n-butanol and 2-ethyl-1-hexanol, cetylalcohol, oleyl alcohol, linoloyl alcohol, oxo alcohols, cyclohexanol, phenol, phenyl ethanol and benzylalcohol.

Thus, the following monohydroxyl compounds [A] may be obtained

MO—(HA)_{y}-OH or MO-(AA-AO)_{y}—OH

wherein

MO is a monoalcohol residue as described above,

HA is a hydroxycarboxylic acid or a lactone thereof as described above,

AA is a dicarboxylic acid as described above,

AO is a polyC₂-C₄alkyleneglycol residue as described above.

Further units may be included in the monohydroxyl compound [A] such as urethane or amide units/functional groups.

The ratio of the molecular weight of unit [A] to [B] is usually in the range of from 1.5:1 to 8:1, preferably 2:1 to 5:1.

Especially preferred phosphoric acid esters are those derived from Me-PEG-OH having a molecular weight generally from 250 to 750 g/mol. It is also preferred that a divalent residue of ε-caprolactone is present as hydroxycarboxylic acid HA. A preferred residue for B is a residue derived from malic acid.

Examples of cationic dispersants are fatty amines condensed with ethylene oxide, long chain primary amines and quaternary ammonium compounds in which there is a quaternary nitrogen atom directly linked to a carbon atom of a hydrophobic radical of at least ten carbon atoms (e.g. a C₁₀-C₂₂alkyl or C₈-C₂₂alkyl aryl, preferably C₈-C₂₂alkyl phenyl or C₈-C₂₂alkyl naphthyl), three valences of the nitrogen atom being also directly linked to other carbon atoms which may be in separate radicals (such as C₁-C₆alkyl radicals, or aralkyl radicals of 6 to 10 carbon atoms, preferably phenyl substituted C₁-C₄alkyl) or in a (hetero)cycle of 1 to 10 carbon atoms including the quaternary nitrogen atom (as in a morpholine, pyridine, quinoline or imidazoline ring); stearyl trimethyl ammonium chloride being a specific example. The ethoxylated amines are preferred.

Yet another preferred embodiment of the instant invention relates to a color filter comprising a colored nanoparticle wherein said nanoparticle, optionally surface-modified with a covalently bound light stabilizer and/or dispersant, is treated with an oxyacid compound or hydrogen oxyacid compound resulting in a coating layer of the colored nanoparticles. Preferably, the anion species of said oxyacid compound or said hydrogen oxyacid compound is a polyvalent oxyacid anion, especially selected from the group consisting of phosphate, tungstate, molybdate, silicate, germanate or vanadate ion each optionally containing transition metals, for instance Zn, Co, Ru and/or Rh.

More preferably, said resulting terminal coating layer essentially consists of molybdenum and tungsten polyoxometallates including, but are not limited to, those of the Lindqvist, Keggin, Wells-Dawson, Preyssler and Sandwich type. Polyoxometallate (abbreviated POM) are metallates containing anions or molecules consisting of transition metal ions bonded to other ligands, preferably oxygen atoms, nitrogen or sulfur, and preferably based upon MoO₆ and/or WO₆ octahedral.

The terminal coating layer may also comprise one or more compounds selected from the group consisting of silicon dioxide, chromium(III)-oxide, chromium(III)-hydroxide, aluminum oxide, aluminum hydroxide, calcium hydroxide, calcium carbonate, calcium oxide, zinc phosphate, zinc hydrogen phosphate, potassium phosphate, potassium hydrogen phosphate, calcium phosphate, calcium hydrogen phosphate, calcium silicate, zirconium silicate, aluminum phosphate, aluminum hydrogen phosphate, titanium oxide, zirconium phosphate, zirconium hydrogen phosphate, sulfuric acid, sodium sulfate, sodium hydrogen sulfate, phosphoric acid, sodium phosphate, sodium hydrogen phosphate, antimony oxide and cerium oxide.

The particle size of the nanoparticles is generally 5 to 500 nm, preferably 5 to 100 nm, more preferably 5 to 50 nm and most preferably 5 to 25 nm.

Nanoparticles of special interest are nano-scaled oxides made by gas-phase, sol-gel processes or water-based processes, which includes controlled acidification of an alkali metal silicate or removal of metal ions from an alkali metal silicate. Examples are SiO₂ (e.g. Aerosil® from Degussa; Ludox® from DuPont; Snowtex® from Nissan Chemical; Levasil® from Bayer; or Sylysia® from Fuji Silysia Chemical), TiO₂ (e.g. NanoTek® from Nanophase), ZrO₂, SnO₂, MgO, ZnO (e.g. Activox® B or Durhan® TZO from Elementis), CeO₂, Al₂O₃, In₂O₃, Sb₂O₃, or mixed oxides, including colloidal silica (e.g. Klebosol®) or organosols (e.g. Hilink® OG from Clariant), or polyhedral oligomeric silsesquioxanes (e.g. POSS® from Hybrid Plastics) with compatibilizing or reactive organic modifications like hydrocarbon, silane or siloxane chains, with or without functional groups such as hydroxyl, amino, mercapto, epoxy or ethylenic groups, or natural or modified semi-synthetic or synthetic (e.g. Somasif® from CO-OP Chemicals) phyllosilicates, organophilic precipitated calcium carbonate (e.g. Socal® from Solvay]) or anion exchanging hydrotalcite (e.g. Hycite® 713 from Ciba Specialty Chemicals) or organophilically modified hydrotalcite or hydrocalumite.

Preferred nanoparticles are organophilically modified natural or synthetic phyllosilicates or a mixture of such phyllosilicates. Especially preferred nanoparticles are organophilically modified montmorillonites (e.g. Nanomer® from Nanocor or Nanofil® from Suedchemie), bentonites (e.g. Cloisite® from Southern Clay Products), beidellites, hectorites, saponites, nontronites, sauconites, vermiculites, ledikites, magadiites, kenyaites or stevensites.

The colored nanoparticles can be prepared in analogy as described in WO 2006/125736 A1.

The preparation of the surface modified nanoparticles comprising on the surface a covalently bound cationic colorant can, for example, be carried out by the reaction of corresponding unmodified nanoparticles, like commercially available silica nanoparticles, with a compound of the formula (IIa)

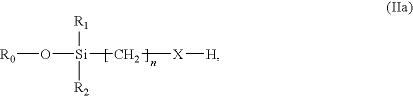

wherein

R₀ is C₁-C₂₅alkyl,

R₁ and R₂ are hydrogen or a substituent as defined above under formula (II),

n is 1, 2, 3, 4, 5, 6, 7 or 8, and

X is a functional group, like —O—, —S— or —N(R₃)—, wherein

R₃ is hydrogen, C₁-C₈alkyl or hydroxyl-substituted C₁-C₈alkyl, preferably hydrogen or C₁-C₄alkyl, especially hydrogen.

In a further step, the reaction product of the nanoparticles with the compound of formula (IIa) can easily be derivatized to obtain surface modified nanoparticles comprising covalently bound a cationic colorant by known processes such as, for example, esterification, amidation, Michael addition or opening of epoxides.

The reaction of the compound of formula (IIa) with the nanoparticles can be carried out in analogy to known processes. The reaction can, for example, be carried out in an organic medium, like ethanol, at elevated temperature. It is preferred to use a compound of formula (IIa), wherein R₀ is methyl and R₁ and R₂ are methoxy.

According to an alternative process for the preparation of colored nanoparticles corresponding unmodified nanoparticles, like commercially available silica nanoparticles, can be reacted with a compound of the formula (IIb)

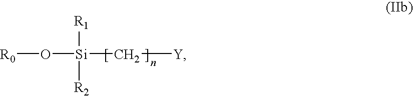

wherein R₀, R₁, R₂ and n are as defined above under formula (IIa) and Y is a radical of a cationic colorant.

The reaction of the compound of formula (IIb) with silica nanoparticles can be carried out in analogy to known processes. The reaction can, for example, be carried out in analogy to the preparation process described in WO 03/002652 A1.

The radicals of light stabilizers or dispersants can be introduced in analogy to the above-mentioned preparation processes. These reactions can be carried out simultaneously with the introduction of the radical of the cationic colorant, or stepwise.

A further embodiment of the present invention relates to a surface-modified nanoparticle wherein

(i) a cationic colorant of a di(tri)-aryl(hetero)-dyestuff, preferably selected from the group consisting of triarylmethane, heteroaryldiarylmethane, diheteroarylarylmethane, xanthene and thioxanthene dyes and further a dispersant are covalently attached to the surface of said nanoparticle; or

(ii) a tri-aryl(hetero)-carbonium pigment is covalently attached to the surface of said nanoparticle.

Preferred embodiments of surface-modified nanoparticles are described above for nanoparticles incorporated in color filters.

The instant invention also relates to the use of surface-modified nanoparticles wherein a cationic colorant is covalently attached to the surface of said nanoparticle for manufacturing color filters.

A further embodiment of the instant invention relates to a polymerizable mixture for making color filters (CF) comprising a colored nanoparticle and at least one ethylenically unsaturated polymerizable compound.

The polymerizable color filter mixture can be used in the manufacture of color filters as a dispersion in an organic solvent or in water. There are several ways to manufacture these color filters, which follow two mainstreams: (a) direct patterning during applying and (b) patterning after applying the colorant, i.e. the colored surface-modified nanoparticle described hereinbefore.

Direct patterning can be obtained by several printing techniques, such as impact (off-set, flexography, gravure, relief, screen, stamping, letterpress etc.) as well as non-impact (e.g. ink jet techniques).

Other direct patterning techniques are based on lamination processes, electronic discharging processes like electro-deposition and some special color proofing methods, like the so-called Chromelin™ process (DuPont).

For impact printing techniques, the colorant, may be dispersed in water or organic solvents by standard de-agglomeration methods (Skandex, Dynamill, Dispermat, Drais and the like) in the presence of a dispersant and a polymeric binder to produce an ink. Any dispersion technique known in the field, including the choice of solvent, dispersant and binder, can be used. The type of ink and its viscosity depend on the application technique and are well known to the skilled artisan. Most usual binders, to which the invention is of course not limited, are (meth)acrylates, epoxies, PVA, polyimides, novolac systems and the like as well as combinations of these polymers.

The ink dispersion then can be printed on all kind of standard printing machines. A heating process preferably achieves curing of the binder system. The three colors can be applied at once or in different printing steps with intermediate drying and/or curing steps, for example one color at the time in three printing steps.

Inks for use in ink jet, for example piezo or bubble jet, can be prepared likewise. They generally contain a colorant, dispersed in water and/or one or a mixture of many hydrophilic organic solvents in combination with a dispersant and a binder.

For ink jet printing a standard ink jet printer can be used or a dedicated printer can be built in order to optimize for example the printing speed etc.

For lamination techniques, like thermal transfer and the like, a web system has to be made: The colorant is dispersed in a solvent or water with dispersant and binder and coated on a foil and dried. The colorant/binder system can be patternwise or uniformly transferred to a color filter substrate with the help of energy (UV, IR, heat, pressure etc.). Depending on the technique used, the colorant, for example, may be transferred alone (dye diffusion or sublimation transfer), or the colorant dispersion may be entirely transferred including the binder (wax transfer).

For electrodeposition, the colorant has to be dispersed in water together with an ionized polymer. By means of an electrical current, the ionized polymer is deionized at the anode or the cathode and, being insoluble then, deposited together with the colorant. This can be done on patterned or patternwise shielded, by a photoresist, (transparent) photo-conductors like ITO etc.

The Chromalin™ process makes use of a photosensitive material, deposited on a color filter substrate. The material becomes tacky upon UV exposure. The so-called ‘toner’, comprising a mixture or compound of pigment and polymer, is distributed on the substrate and sticks on the tacky parts. This process has to be done three to four times for red, green, blue (R,G,B) and eventually black.

Patterning after applying is a method based mostly on the known photoresist technology, wherein the colorant is dispersed in the photoresist composition. Other methods are indirect patterning with the help of a separate photoresist or lamination techniques.

The colorant may be dispersed into photoresists by any standard method such as described above for the printing processes. The binder systems may also be identical. Further suitable compositions are described for example in EP-B-654711, WO-98/45756 or WO-98/45757.

Photoresists comprise a photoinitiator and a poly-crosslinkable monomer (negative radical polymerization), a material to crosslink the polymers itself (for example a photoacid generator or the like) or a material to chemically change the solubility of the polymer in certain developing media. This process, however, can also be done with heat (for example using thermal arrays or an NIR beam) instead of UV, in the case of some polymers, which undergo chemical changes during heating processes, resulting in changes of solubility in the mentioned developing media. There is then no need for a photoinitiator.

The photosensitive or heat sensible material is coated on a color filter substrate, dried and UV (or heat) irradiated, sometimes again baked (photoacid generators) and developed with a developing medium (mostly a base). In this last step only the non-exposed (negative systems) or only the exposed (positive systems) parts are washed away, giving the wanted pattern. This operation has to be repeated for all the colors used.

Photosensitive lamination techniques are using the same principle, the only difference being the coating technique. A photosensitive system is applied as described above, however, on a web instead of a color filter substrate. The foil is placed on the color filter substrate and the photosensitive layer is transferred with the help of heat and/or pressure.

Indirect processes, with the above-mentioned polymeric binders without a photosensitive component, make use of an extra photoresist, coated on top of the pigmented resist. During the patterning of the photoresist, the pigmented resist is patterned as well. The photoresist has to be removed afterwards.

The instant printing inks or photoresists for making color filters contain the surface-modified nanoparticle described hereinbefore judiciously in an amount of from 1 to 75% by weight, preferably from 5 to 50% by weight, with particular preference from 25 to 40% by weight, based on the total weight of the printing ink or photoresist.

The polymerizable color filter mixture of the present invention generally contains 0.01 to 40% by weight, preferably 1 to 25% by weight and more preferably 2 to 20% by weight, based on the whole solid content of the mixture, i.e. the amount of all components without the solvent(s), of the colored nanoparticles.

In the polymerizable color filter mixture the content of the ethylenically unsaturated compounds is generally 5 to 80% by weight, preferably 5 to 70% by weight and in particular 7 to 30% by weight, based on the whole solid content of the mixture, i.e. the amount of all components without the solvent(s).

Preferred are mixtures which comprises from 40 to 350% by weight, of an ethylenically unsaturated polymerizable compound, based on the amount of the colored nanoparticles. More preferred is from 50 to 200% by weight of an ethylenically unsaturated polymerizable compound, based on the amount of the colored nanoparticle. The polymerizable compound is suitably either liquid or dissolved in water and/or a liquid solvent having a boiling point from 25 to 250° C., preferably of a boiling point from 35 to 150° C.

The content of the binder in the color filter mixture is generally 2 to 98% by weight, preferably 10 to 90% by weight, and more preferably 20 to 80% by weight, based on the whole solid content of the mixture, i.e. the amount of all components without the solvent(s).

As the binder used in the color filter mixture, which is soluble in an alkaline aqueous solution and insoluble in water, for example, a homopolymer of a polymerizable compound having one or more acid groups and one or more polymerizable unsaturated bonds in the molecule, or a copolymer of two or more kinds thereof, or a copolymer of one or more polymerizable compounds having one or more unsaturated bonds copolymerizable with these compounds and containing no acid group, can be used. Such compounds can be obtained by copolymerizing one or more kinds of a low molecular weight compound having one or more acid groups and one or more polymerizable unsaturated bonds in the molecule with one or more polymerizable compounds having one or more unsaturated bonds copolymerizable with these compounds and containing no acid group. Examples of acid groups are a —COOH group, a —SO₃H group, a —SO₂NHCO— group, a phenolic hydroxy group, a —SO₂NH— group, and a —CO—NH—CO— group. Among those, a high molecular weight compound having a —COOH group is particularly preferred.

Preferably, the binder in the color filter resist composition comprises an alkali soluble copolymer comprising, as addition polymerizable monomer units, at least an unsaturated organic acid compound such as acrylic acid, methacrylic acid and the like. It is preferred to use as a further co-monomer for the binder an unsaturated organic acid ester compound such as methyl(meth)acrylate, ethyl(meth)acrylate, benzyl(meth)acrylate, styrene and the like to balance properties such as alkaline solubility, adhesion rigidity, chemical resistance etc., if desired.

The binder can either be a random co-polymer or a block-co-polymer, for example, such as described in U.S. Pat. No. 5,368,976.

Examples of polymerizable compounds having one or more acid groups and one or more polymerizable unsaturated bonds in the molecule as starting materials for the binder include the following compounds:

Examples of the polymerizable compounds having one or more —COOH groups and one or more polymerizable unsaturated bonds in a molecule are (meth)acrylic acid, 2-carboxyethyl (meth)acrylic acid, 2-carboxypropyl(meth)acrylic acid, crotonic acid, cinnamic acid, mono[2-(meth)acryloyloxyethyl]succinate, mono[2-(meth)acryloyloxyethyl]adipate, mono[2-(meth)acryloyloxyethyl]phthalate, mono[2-(meth)acryloyloxyethyl]hexahydrophthalate, mono[2-(meth)acryloyloxyethyl]maleate, mono[2-(meth)acryloyloxypropyl]succinate, mono[2-(meth)acryloyloxypropyl]adipate, mono[2-(meth)acryloyloxypropyl]phthalate, mono[2-(meth)acryloyloxypropyl]hexahydrophthalate, mono[2-(meth)acryloyloxypropyl]maleate, mono[2-(meth)acryloyloxybutyl]succinate, mono[2-(meth)acryloyloxybutyl]adipate, mono[2-(meth)acryloyloxybutyl]phthalate, mono[2-(meth)acryloyloxybutyl]hexahydrophthalate, mono[2-(meth)acryloyloxybutyl]maleate, 3-(alkylcarbamoyl)acrylic acid, a-chloroacrylic acid, maleic acid, monoesterified maleic acid, fumaric acid, itaconic acid, citraconic acid, mesaconic acid, maleic anhydride, and w-carboxypolycaprolactone mono(meth)acrylate.

Vinylbenzenesulfonic acid, 2-(meth)acrylamide-2-methylpropanesulfonic acid, vinylsulfonic acid and (meth)allylsulfonic acid are examples of the polymerizable compounds having one or more —SO₃H groups and one or more polymerizable unsaturated bonds.

N-methylsulfonyl(meth)acrylamide, N-ethylsulfonyl(meth)acrylamide, N-phenylsulfonyl(meth)acrylamide, and N-(p-methylphenylsulfonyl)(meth)acrylamide are examples of the polymerizable compounds having one or more —SO₂NHCO— groups and one or more polymerizable unsaturated bonds.

Examples of polymerizable compounds having one or more phenolic hydroxy groups and one or more polymerizable unsaturated bonds in a molecule include hydroxyphenyl(meth)acrylamide, dihydroxyphenyl(meth)acrylamide, hydroxyphenylcarbonyloxyethyl(meth)acrylate, hydroxyphenyloxyethyl(meth)acrylate, hydroxyphenylthioethyl(meth)acrylate, dihydroxyphenylcarbonyloxyethyl(meth)acrylate, dihydroxyphenyloxyethyl(meth)acrylate, and dihydroxy-phenylthioethyl(meth)acrylate.

Examples of the polymerizable compound having one or more —SO₂NH— groups and one or more polymerizable unsaturated bonds in the molecule include compounds represented by formula (a) or (b):

CH₂═CA₁-Y₁-A₂-SO₂—NH-A₃ (a)

CH₂═CA₄-Y₂-A₅-NH—SO₂-A₆ (b)

wherein Y₁ and Y₂ each represents —COO—, —CONA₇-, or a single bond; A₁ and A₄ each represents H or CH₃; A₂ and A₅ each represents C₁-C₁₂alkylene optionally having a substituent, cycloalkylene, arylene, or aralkylene, or C₂-C₁₂alkylene into which an ether group and a thio-ether group are inserted, cycloalkylene, arylene, or aralkylene; A₃ and A₆ each represents H, C₁-C₁₂alkyl optionally having a substituent, a cycloalkyl group, an aryl group, or an aralkyl group; and A₇ represents H, C₁-C₁₂alkyl optionally having a substituent, a cycloalkyl group, an aryl group, or an aralkyl group.

The polymerizable compounds having one or more —CO—NH—CO— groups and one or more polymerizable unsaturated bonds include maleimide and N-acryloyl-acrylamide. These polymerizable compounds become the high molecular weight compounds comprising a —CO—NH—CO— group, in which a ring is formed together with a primary chain by polymerization. Further, a methacrylic acid derivative and an acrylic acid derivative each having a —CO—NH—CO— group can be used as well. Such methacrylic acid derivatives and the acrylic acid derivatives include, for example, a methacrylamide derivative such as N-acetylmethacrylamide, N-propionylmethacrylamide, N-butanoylmethacrylamide, N-pentanoylmethacrylamide, N-decanoylmethacrylamide, N-dodecanoylmethacrylamide, N-benzoylmethacrylamide, N-(p-methylbenzoyl)methacryl-amide, N-(p-chlorobenzoyl)methacrylamide, N-(naphthyl-carbonyl)methacrylamide, N-(phenylacetyl)-methacryl-amide, and 4-methacryloylaminophthalimide, and an acrylamide derivative having the same substituent as these. These polymerizable compounds polymerize to be compounds having a —CO—NH—CO— group in a side chain.

Examples of polymerizable compounds having one or more polymerizable unsaturated bonds and containing no acid group include a compound having a polymerizable unsaturated bond, selected from esters of (meth)acrylic acid, such as methyl(meth)acrylate, ethyl(meth)acrylate, propyl(meth)acrylate, butyl(meth)acrylate, tetrahydrofurfuryl(meth)acrylate, benzyl(meth)acrylate, 2-ethylhexyl(meth)acrylate, hydroxyethyl(meth)acrylate, hydroxypropyl(meth)acrylate, hydroxybutyl(meth)acrylate, glycerol mono(meth)acrylate, dihydroxypropyl(meth)acrylate, allyl(meth)acrylate, cyclohexyl(meth)acrylate, phenyl(meth)acrylate, methoxyphenyl(meth)acrylate, methoxyethyl(meth)acrylate, phenoxyethyl(meth)acrylate, methoxydiethyleneglycol(meth)acrylate, methoxytriethyleneglycol(meth)acrylate, methoxypropyl(meth)acrylate, methoxydipropyleneglycol(meth)acrylate, isobornyl meth(acrylate), dicyclopentadienyl(meth)acrylate, 2-hydroxy-3-phenoxypropyl(meth)acrylate, tricyclo[5.2.1.0^{2,6}]decan-8-yl(meth)acrylate, aminoethyl(meth)acrylate, N,N-dimethylaminoethyl(meth)acrylate, aminopropyl(meth)acrylate, N,N-dimethylaminopropyl(meth)acrylate, glycidyl(meth)acrylate, 2-methylglycidyl(meth)acrylate, 3,4-epoxybutyl(meth)acrylate, 6,7-epoxyheptyl(meth)acrylate; vinyl aromatic compounds, such as styrene, α-methylstyrene, vinyltoluene, p-chlorostyrene, polychlorostyrene, fluorostyrene, bromostyrene, ethoxymethyl styrene, methoxystyrene, 4-methoxy-3-methylstyrene, dimethoxystyrene, vinylbenzyl methyl ether, vinylbenzyl glycidyl ether, indene, 1-methylindene; vinyl or allyl esters, such as vinyl acetate, vinyl propionate, vinyl butylate, vinyl pivalate, vinyl benzoate, vinyl trimethylacetate, vinyl diethylacetate, vinyl borate, vinyl caproate, vinyl chloroacetate, vinyl dichloroacetate, vinyl methoxyacetate, vinyl butoxyacetate, vinyl phenylacetate, vinyl acetate, vinyl acetoacetate, vinyl lactate, vinyl phenylbutylate, vinyl cyclohexylcarboxylate, vinyl salicylate, vinyl chlorobenzoate, vinyl tetrachlorobenzoate, vinyl naphthoate, allyl acetate, allyl propionate, allyl butylate, allyl pivalate, allyl benzoate, allyl caproate, allyl stearate, allyl acetoacetate, allyl lactate; vinyl or allyl ethers, such as vinyl methyl ether, vinyl ethyl ether, vinyl hexyl ether, vinyl octyl ether, vinyl ethylhexyl ether, vinyl methoxyethyl ether, vinyl ethoxyethyl ether, vinyl chloroethyl ether, vinyl hydroxyethyl ether, vinyl ethybutyl ether, vinyl hydroxyethoxyethyl ether, vinyl dimethylaminoethyl ether, vinyl diethylaminoethyl ether, vinyl butylaminoethyl ether, vinyl benzyl ether, vinyl tetrahydrofurfuryl ether, vinyl phenyl ether, vinyl tolyl ether, vinyl chlorophenyl ether, vinyl chloroethyl ether, vinyl dichlorophenyl ether, vinyl naphthyl ether, vinyl anthryl ether, allyl glycidyl ether; amide type unsaturated compounds, such as (meth)acrylamide, N,N-dimethyl(meth)acrylamide, N,N-diethyl(meth)acrylamide, N,N-dibutyl(meth)acrylamide, N,N-diethylhexyl(meth)acrylamide, N,N-dicyclohexyl(meth)acrylamide, N,N-diphenyl(meth)acrylamide, N-methyl-N-phenyl(meth)acrylamide, N-hydroxyethyl-N-methyl(meth)acrylamide, N-methyl(meth)acrylamide, N-ethyl(meth)acrylamide, N-propyl(meth)acrylamide, N-butyl(meth)acrylamide, N-hydroxyethyl(meth)acrylamide, N-heptyl(meth)acrylamide, N-octyl(meth)acrylamide, N-ethyhexyl(meth)acrylamide, N-hydroxyethyl(meth)acrylamidecyclohexyl, N-benzyl(meth)acrylamide, N-phenyl(meth)acrylamide, N-tolyl(meth)acrylamide, N-hydroxyphenyl(meth)acrylamide, N-naphthyl(meth)acrylamide, N-phenylsulfonyl(meth)acrylamide, N-methylphenylsulfonyl(meth)acrylamide and N-(meth)acryloylmorpholine, diacetone acrylamide, N-methylol acrylamide, N-butoxyacrylamide; polyolefin type compounds, such as butadiene, isoprene, chloroprene and the like; (meth)acrylonitrile, methyl isopropenyl ketone, maleimide, N-phenylmaleimide, N-methylphenylmaleimide, N-methoxyphenylmaleimide, N-cyclohexylmaleimide, N-alkylmaleimide, maleic anhydride, polystyrene macromonomer, polymethyl(meth)acrylate macromonomer, polybutyl(meth)acrylate macromonomer; crotonates, such as butyl crotonate, hexyl crotonate, glycerine monocrotonate; and itaconates, such as dimethyl itaconate, diethyl itaconate, dibutyl itaconate; and maleates or fumarates, such as dimethyl maleate, dibutyl fumarate.

Preferable examples of copolymers are copolymers of methyl(meth)acrylate and (meth)acrylic acid, copolymers of benzyl(meth)acrylate and (meth)acrylic acid, copolymers of methyl(meth)acrylate, ethyl(meth)acrylate and (meth)acrylic acid, copolymers of benzyl(meth)acrylate, (meth)acrylic acid and styrene, copolymers of benzyl(meth)acrylate, (meth)acrylic acid and 2-hydroxyethyl(meth)acrylate, copolymers of methyl(meth)acrylate, butyl(meth)acrylate, (meth)acrylic acid and styrene, copolymers of methyl(meth)acrylate, benzyl(meth)acrylate, (meth)acrylic acid and hydroxyphenyl(meth)acrylate, copolymers of methyl(meth)acrylate, (meth)acrylic acid and polymethyl(meth)acrylate macromonomer, copolymers of benzyl(meth)acrylate, (meth)acrylic acid and polymethyl(meth)acrylate macromonomer, copolymers of tetrahydrofurfuryl(meth)acrylate, styrene and (meth)acrylic acid, copolymers of methyl(meth)acrylate, (meth)acrylic acid and polystyrene macromonomer, copolymers of benzyl(meth)acrylate, (meth)acrylic acid and polystyrene macromonomer, copolymers of benzyl(meth)acrylate, (meth)acrylic acid, 2-hydroxyethyl(meth)acrylate and polystyrene macromonomer, copolymers of benzyl(meth)acrylate, (meth)acrylic acid, 2-hydroxypropyl(meth)acrylate and polystyrene macromonomer, copolymers of benzyl(meth)acrylate, (meth)acrylic acid, 2-hydroxy-3-phenoxypropyl(meth)acrylate and polymethyl(meth)acrylate macromonomer, copolymers of methyl(meth)acrylate, (meth)acrylic acid, 2-hydroxyethyl(meth)acrylate and polystyrene macromonomer, copolymers of benzyl(meth)acrylate, (meth)acrylic acid, 2-hydroxyethyl(meth)acrylate and polymethyl(meth)acrylate macromonomer, copolymers of N-phenylmaleimide, benzyl(meth)acrylate, (meth)acrylic acid and styrene, copolymers of benzyl(meth)acrylate, (meth)acrylic acid, N-phenylmaleimide, mono-[2-(meth)acryloyloxyethyl]succinate and styrene, copolymers of allyl(meth)acrylate, (meth)acrylic acid, N-phenylmaleimide, mono-[2-(meth)acryloyloxyethyl]succinate and styrene, copolymers of benzyl(meth)acrylate, (meth)acrylic acid, N-phenylmaleimide, glycerol mono(meth)acrylate and styrene, copolymers of benzyl(meth)acrylate, ω-carboxypolycaprolactone mono(meth)acrylate, (meth)acrylic acid, N-phenylmaleimide, glycerol mono(meth)acrylate and styrene, and copolymers of benzyl(meth)acrylate, (meth)acrylic acid, N-cyclohexylmaleimide and styrene.

There can be used as well hydroxystyrene homo- or co-polymers or a novolac type phenol resin, for example, poly(hydroxystyrene) and poly(hydroxystyrene-co-vinylcyclohexanol), a novolac resin, a cresol novolac resin, and a halogenated phenol novolac resin. More specifically, it includes, for example, the methacrylic acid copolymers, the acrylic acid copolymers, the itaconic acid copolymers, the crotonic acid copolymers, the maleic anhydride co-polymers, for example, with styrene as a co-monomer, and maleic acid copolymers, and partially esterified maleic acid copolymers each described in, for example, JP 59-44615-B4 (the term “JP-B4” as used herein refers to an examined Japanese patent publication), JP 54-34327-B4, JP 58-12577-B4, and JP 54-25957-B4, JP 59-53836-A, JP 59-71048-A, JP 60-159743-A, JP 60-258539-A, JP 1-152449-A, JP 2-199403-A, and JP 2-199404-A, and which copolymers can be further reacted with an amine, as e.g. disclosed in U.S. Pat. No. 5,650,263; further, a cellulose derivative having a carboxyl group on a side chain can be used, and particularly preferred are copolymers of benzyl(meth)acrylate and (meth)acrylic acid and copolymers of benzyl(meth)acrylate, (meth)acrylic acid and other monomers, for example, as described in U.S. Pat. No. 4,139,391, JP 59-44615-B4, JP 60-159743-A and JP 60-258539-A.

With respect to those having carboxylic acid groups among the above binder polymers, it is possible to react some or all of the carboxylic acid groups with glycidyl(meth)acrylate or an epoxy(meth)acrylate to obtain photopolymerizable binder polymers for the purpose of improving the photosensitivity, coating film strength, the coating solvent and chemical resistance and the adhesion to the substrate. Examples are disclosed in JP 50-34443-B4 and JP 50-34444-B4, U.S. Pat. No. 5,153,095, by T. Kudo et al. in J. Appl. Phys., Vol. 37 (1998), p. 3594-3603, U.S. Pat. No. 5,677,385, and U.S. Pat. No. 5,650,233.

Examples of solvent developable binder polymers are poly(alkyl methacrylates), poly(alkyl acrylates), poly(benzylmethacrylate-co-hydroxyethylmethacrylate-co-methacrylic acid), poly(benzylmethacrylate-co-methacrylic acid); cellulose esters and cellulose ethers, such as cellulose acetate, cellulose acetobutyrate, methylcellulose, ethylcellulose; polyvinylbutyral, polyvinylformal, cyclized rubber, polyethers such as polyethylene oxide, polypropylene oxide and polytetrahydrofuran; polystyrene, polycarbonate, polyurethane, chlorinated polyolefins, polyvinyl chloride, vinyl chloride/vinylidene copolymers, copolymers of vinylidene chloride with acrylonitrile, methyl methacrylate and vinyl acetate, polyvinyl acetate, copoly(ethylene/vinyl acetate), polymers such as polycaprolactam and poly(hexamethylene adipamide), and polyesters such as poly(ethylene glycol terephtalate) and poly(hexamethylene glycol succinate) and polyimide binder resins.

The polyimide binder resin in the present invention can either be a solvent soluble polyimide or a polyimide precursor, for example, a poly(amic acid).

Preferred is a photopolymerizable mixture, comprising as binder a copolymer of methacrylate and methacrylic acid, more preferably a copolymer of benzyl methacrylate and methacrylic acid.

Further suitable binder components are described, for example, in JP 10-171119-A, in particular for use in color filters.

The choice of binder is made depending on the field of application and on properties required for this field, such as the capacity for development in aqueous and organic solvent systems, adhesion to substrates and sensitivity to oxygen.

The weight-average molecular weight of the binders is preferably 500 to 2,000,000, e.g. 3,000 to 1,000,000, more preferably 5,000 to 400,000 g/mol.

The binder may be used singly or as a mixture of two or more kinds in any desired ratio.

As mentioned above, the present invention also relates to a polymerizable mixture for making color filters comprising a colored nanoparticle and at least one ethylenically unsaturated polymerizable compound.

Preferably, this polymerizable mixture further comprises at least one photoinitiator and can be photopolymerized upon irradiation.

As ethylenically unsaturated compound compounds having one or more olefinic double bonds, which also may be polymerizable oligomers, can be used. Examples of compounds containing one double bond are (meth)acrylic acid, (cyclo)alkyl, hydroxyalkyl or aminoalkyl(meth)acrylates, for example methyl, ethyl, n-butyl, isobutyl, tert-butyl, n-propyl, isopropyl, n-hexyl, cyclohexyl, 2-ethylhexyl, isobornyl, benzyl, 2-hydroxyethyl, 2-hydroxypropyl, methoxyethyl, ethoxyethyl, glycerol, phenoxyethyl, methoxydiethylene glycol, ethoxydiethylene glycol, polyethylene glycol, polypropylene glycol, glycidyl, N,N-dimethylaminoethyl, and N,N-diethylaminoethyl(meth)acrylates. Other examples are (meth)acrylonitrile, (meth)acrylamide, N-substituted (meth)acrylamides such as N,N-dimethyl(meth)acrylamide, N,N-diethyl(meth)acrylamide, N,N-dibutyl(meth)acrylamide, N-methyl(meth)acrylamide, N-ethyl(meth)acrylamide, N-butyl(meth)acrylamide, and N-(meth)acryloylmorpholine, vinyl esters such as vinyl acetate, vinyl ethers such as isobutyl vinyl ether, styrene, alkyl-, hydroxy- and halostyrenes, N-vinylpyrrolidone, N-vinylcaprolactam, N-vinylacetoamide, N-vinylformamide, vinyl chloride and vinylidene chloride.

Examples of polymerizable oligomers having two or more double bonds are polyesters, polyurethanes, polyethers and polyamides, which contain ethylenically unsaturated carboxylates.

Particularly suitable examples are esters of an ethylenically unsaturated carboxylic acid with a polyol or polyepoxide.

Examples of unsaturated carboxylic acids are acrylic acid, methacrylic acid, crotonic acid, itaconic acid, cinnamic acid, and unsaturated fatty acids such as linolenic acid or oleic acid. Acrylic and methacrylic acids are preferred.

Suitable polyols are aromatic, aliphatic and cycloaliphatic polyols, in particular, aliphatic and cycloaliphatic polyols. Examples of aromatic polyols are hydroquinone, 4,4′-dihydroxydiphenyl, 2,2-bis(4-hydroxyphenyl)methane, 2,2-bis(4-hydroxyphenyl)propane, 2,2-bis(4-hydroxyphenyl)hexafluoropropane, 9,9-bis(4-hydroxyphenyl)fluorene, novolacs and resols. Examples of aliphatic and cycloaliphatic polyols are alkylenediols having preferably 2 to 12 C atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500 g/mol, 1,3-cyclopentanediol, 1,2-, 1,3- or 1,4-cyclohexanediol, 1,4-dihydroxymethylcyclohexane, glycerol, triethanolamine, trimethylolethane, trimethylolpropane, pentaerythritol, pentaerythritol monooxalate, dipentaerythritol, ethers of pentaerythritol with ethylene glycol or propylene glycol, ethers of dipentaerythritol with ethylene glycol or propylene glycol, sorbitol, 2,2-bis[4-(2-hydroxyethoxy)phenyl]methane, 2,2-bis[4-(2-hydroxyethoxy)phenyl]propane and 9,9-bis[4-(2-hydroxyethoxy)phenyl]fluorene. Other suitable polyols are polymers and copolymers containing hydroxyl groups in the polymer chain or in side groups, examples being homopolymers or copolymers comprising vinyl alcohol or comprising hydroxyalkyl(meth)acrylates. Further suitable polyols are esters and urethanes having hydroxyl end groups.

The polyols may be partially or completely esterified with one unsaturated carboxylic acid or with different unsaturated carboxylic acids, and in partial esters the free hydroxyl groups may be modified, for example etherified or esterified with other carboxylic acids.

Examples of esters based on polyols are trimethylolpropane tri(meth)acrylate, trimethylolpropane tri(acryloyloxypropyl)ether, trimethylolethane tri(meth)acrylate, ethylene glycol di(meth)acrylate, diethylene glycol di(meth)acrylate, triethylene glycol di(meth)acrylate, tetraethylene glycol di(meth)acrylate, tetramethylene glycol di(meth)acrylate, neopentyl glycol di(meth)acrylate, pentaerythritol di(meth)acrylate, pentaerythritol tri(meth)acrylate, pentaerythritol tetra(meth)acrylate, pentaerythritol tri(meth)acrylate monooxalate, dipentaerythritol di(meth)acrylate, dipentaerythritol tri(meth)acrylate, dipentaerythritol tetra(meth)acrylate, dipentaerythritol penta(meth)acrylate, dipentaerythritol hexa(meth)acrylate, dipentaerythritol penta(meth)acrylate mono(2-hydroxyethyl) ether, tripentaerythritol octa(meth)acrylate, 1,3-butanediol di(meth)acrylate, 1,4-butanediol diitaconate, hexanediol di(meth)acrylate, 1,4-cyclohexanediol di(meth)acrylate, sorbitol tri(meth)acrylate, sorbitol tetra(meth)acrylate, sorbitol penta(meth)acrylate, sorbitol hexa(meth)acrylate, oligoester of (meth)acrylates, glycerol di(meth)acrylate and tri(meth)acrylate, di(meth)acrylates of polyethylene glycol with a molecular weight of from 200 to 1500, pentaerythritol diitaconate, dipentaerythritol trisitaconate, dipentaerythritol pentaitaconate, dipentaerythritol hexaitaconate, ethylene glycol diitaconate, propylene glycol diitaconate, 1,3-butanediol diitaconate, 1,4-butanediol diitaconate, tetramethylene glycol diitaconate, sorbitol tetraitaconate, ethylene glycol dicrotonate, tetramethylene glycol dicrotonate, pentaerythritol dicrotonate, ethylene glycol dimaleate, triethylene glycol dimaleate, pentaerythritol dimaleate, sorbitol tetramaleate, or mixtures thereof.

Other examples are pentaerythritol and dipentaerythritol derivatives shown in the following formula (XII) and (XIII).

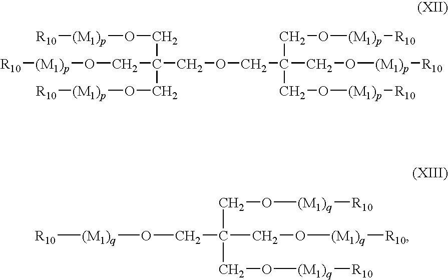

wherein

each M₁ independently is —(CH₂CH₂O)— or —[CH₂CH(CH₃)O]—,

each R₁₀ independently is —COCH═CH₂ or —COC(CH₃)═CH₂,

each p is 0 to 6 where the sum of all p is in the range of from 3 to 24, and

each q is 0 to 6 where the sum of all q is in the range of from 2 to 16.

Examples of polyepoxides are those based on the above-mentioned polyols and epichloro-hydrin. Typical examples are bis(4-glycidyloxyphenyl)methane, 2,2-bis(4-glycidyloxyphenyl)propane, 2,2-bis(4-glycidyloxyphenyl)hexafluoropropane, 9,9-bis(4-glycidyloxyphenyl)fluorene, bis[4-(2-glycidyloxyethoxy)phenyl]methane, 2,2-bis[4-(2-glycidyloxyethoxy)phenyl]propane, 2,2-bis[4-(2-glycidyloxyethoxy)phenyl]hexafluoropropane, 9,9-bis[4-(2-glycidyloxyethoxy)phenyl]fluorene, bis[4-(2-glycidyloxypropoxy)phenyl]methane, 2,2-bis[4-(2-glycidyloxypropoxy)phenyl]propane, 2,2-bis[4-(2-glycidyloxypropoxy)phenyl]hexafluoropropane, 9,9-bis[4-(2-glycidyloxypropoxy)phenyl]fluorene, and glycidyl ethers of phenol and cresol novolacs.

Typical examples of the at least one ethylenically unsaturated compound which is based on polyepoxides include 2,2-bis[4-{(2-hydroxy-3-acryloxy)propoxy}phenyl]propane, 2,2-bis[4-{(2-hydroxy-3-acryloxy)propoxyethoxy}phenyl]propane, 9,9-bis[4-{(2-hydroxy-3-acryloxy)propoxy}phenyl]fluorene, 9,9-bis[4-{(2-hydroxy-3-acryloxy)propoxyethoxy}phenyl]fluorene, and reaction products of epoxy resins based on novolacs with (meth)acrylic acid.

Polyethers obtained from the reaction of the above-mentioned polyols or polyepoxides with the unsaturated compounds with a hydroxy group such as 2-hydroxyethyl(meth)acrylate, vinyl alcohol can also be used as the at least one ethylenically unsaturated compound.

Also suitable as the at least one ethylenically unsaturated compound are the amides of identical or different, unsaturated carboxylic acids with aromatic, cycloaliphatic and aliphatic polyamines having preferably 2 to 6, especially 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-R-aminoethyl ether, diethylenetriamine, triethylenetetramine, di(R-aminoethoxy)- or di(R-aminopropoxy)ethane. Other suitable polyamines are polymers and copolymers, preferably with additional amino groups in the side chain, and oligoamides having amino end groups. Examples of such unsaturated amides are methylenebisacrylamide, 1,6-hexamethylenebisacrylamide, diethylenetriaminetrismethacrylamide, bis(methacrylamidopropoxy)ethane, R-methacrylamidoethyl methacrylate and N[(R-hydroxyethoxy)ethyl]acrylamide.

Other examples are unsaturated urethanes derived from a polyisocyanate and an unsaturated compound having a hydroxy group or from a polyisocyanate, a polyol and an unsaturated compound having a hydroxy group.

Other examples are polyesters, polyamides, or polyurethanes having ethylenically unsaturated groups in the chain. Suitable unsaturated polyesters and polyamides are also derived, for example, from maleic acid and diols or diamines. Some of the maleic acid can be replaced by other dicarboxylic acids. The polyesters and polyamides may also be derived from dicarboxylic acids and ethylenically unsaturated diols or diamines, especially from those with relatively long chains of, for example 6 to 20 C atoms. Examples of polyurethanes are those composed of saturated or unsaturated diisocyanates and of unsaturated or, respectively, saturated diols.

Other suitable polymers with acrylate or methacrylate groups in the side chains are, for example, solvent soluble or alkaline soluble polyimide precursors, for example poly(amic acid ester) compounds, having polymerizable side groups either attached to the backbone or to the ester groups in the molecule. Such oligomers or polymers can be formulated optionally with reactive diluents, like polyfunctional (meth)acrylates in order to prepare highly sensitive polyimide precursor resists.

Further examples of the at least one ethylenically unsaturated compound include also polymers or oligomers having at least one carboxyl function and at least two ethylenically unsaturated groups within the molecular structure, such as a resin obtained by the reaction of a saturated or unsaturated polybasic acid anhydride with a product of the reaction of phenol or cresol novolac epoxy resin and an unsaturated monocarboxylic acid, for example, commercial products such as EB9696, UCB Chemicals; KAYARAD TCR1025, Nippon Kayaku Co., LTD. Examples of the polybasic acid anhydride are maleic anhydride, succinic anhydride, itaconic anhydride, phthalic anhydride, tetrahydrophthalic anhydride, hexahydrophthalic anhydride, methyltetrahydrophthalic anhydride, glutaric anhydride, glutaconic anhydride, citraconic anhydride, diglycolic anhydride, iminodiacetic anhydride, 1,1-cyclopentanediacetic anhydride, 3,3-dimethylglutaric anhydride, 3-ethyl-3-methylglutaric anhydride, 2-phenylglutaric anhydride, homophthalic anhydride, trimellitic anhydride, chlorendic anhydride, pyromellitic dianhydride, benzophenone tetracarboxylic acid dianhydride, biphenyl tetracarboxylic acid dianhydride, and biphenylether tetracarboxylic acid dianhydride.

Other examples are the products from the polycondensation reaction and/or addition reaction of the compound of formula (XIV) with one or more above-mentioned polybasic acid anhydrides.

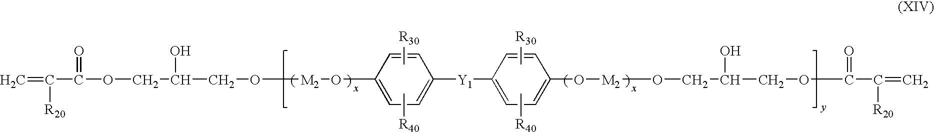

wherein Y₁ is

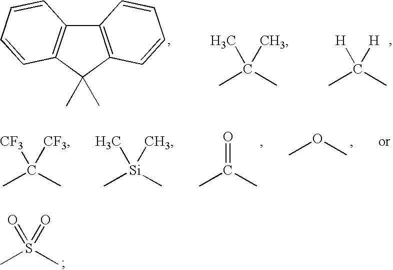

R₂₀ is hydrogen or methyl,

R₃₀ and R₄₀ independently of each other are hydrogen, methyl, Cl, or Br, M₂ is substituted or unsubstituted alkylene having 1 to 10 carbon atoms, x is 0 to 5, and y is 1 to 10.

A preferred polymerizable mixture comprises as ethylenically unsaturated compound a compound having at least two ethylenically unsaturated bonds and at least one carboxylic acid group in the molecule, in particular a reaction product obtained by adding an epoxy group containing unsaturated compound to a part of the carboxyl groups of a carboxylic acid group containing polymer or a reaction product of the compound shown below with one or more polybasic acid anhydrides. Further preferred ethylenically unsaturated compounds comprise a compound of the formula XIV.

Further examples are reaction products obtained by adding an epoxy group containing unsaturated compound to a part of the carboxyl groups of a carboxylic acid group containing polymer. As the carboxylic acid containing polymer, the above-mentioned binder polymers which are resulting from the reaction of an unsaturated carboxylic acid compound with one or more polymerizable compounds, for example, copolymers of (meth)acrylic acid, benzyl(meth)acrylate, styrene and 2-hydroxyethyl(meth)acrylate, copolymers of (meth)acrylic acid, styrene and α-methylstyrene, copolymers of (meth)acrylic acid, N-phenylmaleimide, styrene and benzyl(meth)acrylate, copolymers of (meth)acrylic acid and styrene, copolymers of (meth)acrylic acid and benzyl(meth)acrylate, copolymers of tetrahydrofurfuryl(meth)acrylate, styrene and (meth)acrylic acid, and the like.

Examples of the unsaturated compounds having an epoxy group are given below in the formula (V-1)-(V-15);

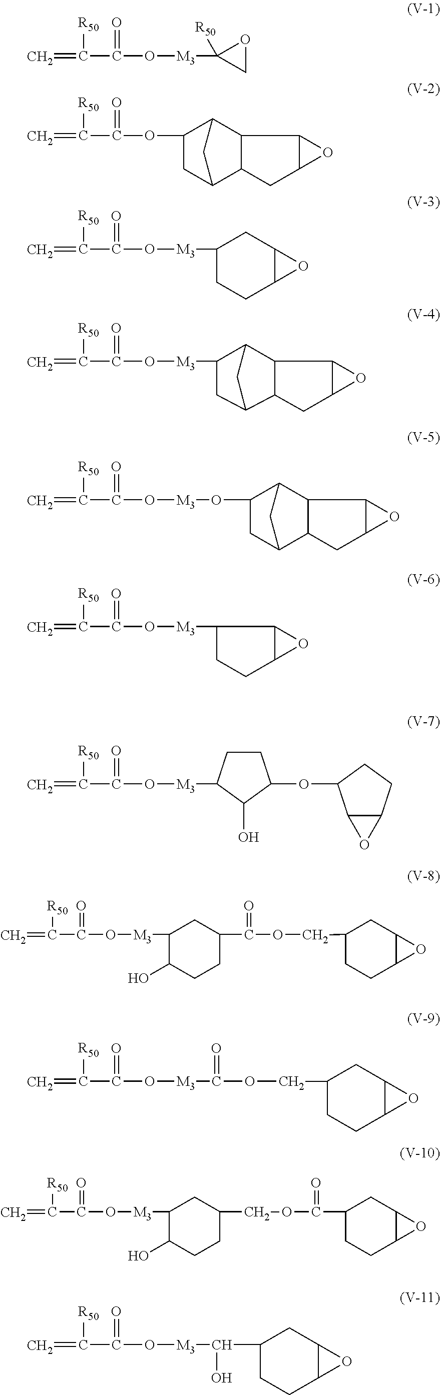

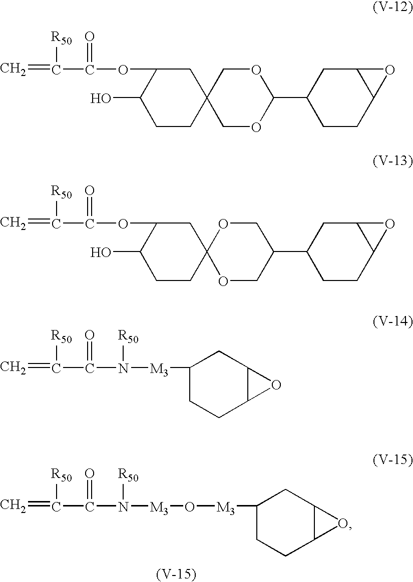

wherein R₅₀ is hydrogen or a methyl group, M₃ is substituted or unsubstituted alkylene having 1 to 10 carbon atoms.

Among these compounds, compounds having alicyclic epoxy groups are particularly preferred, because these compounds have a high reactivity with carboxyl group containing resins, accordingly the reaction time can be shortened. These compounds further do not cause gelation in the process of reaction and make it possible to carry out the reaction stably. On the other hand, glycidyl acrylate and glycidyl methacrylate are advantageous from the viewpoint of sensitivity and heat resistance because they have a low molecular weight and can give a high conversion of esterification.

Concrete examples of the above-mentioned compounds are, for example, a reaction product of a copolymer of styrene, alpha-methyl styrene and acrylic acid or a copolymer of methyl methacrylate and acrylic acid with 3,4-epoxycyclohexylmethyl(meth)acrylate.

Unsaturated compounds having a hydroxy group such as 2-hydroxyethyl(meth)acrylate and glycerol mono(meth)acrylate can be used instead of the above-mentioned epoxy group containing unsaturated compounds as the reactant for carboxylic acid group containing polymers.

Other examples are half esters of anhydride containing polymers, for example reaction products of a copolymer of maleic anhydride and one or more other polymerizable compounds with (meth)acrylates having an alcoholic hydroxy group such as 2-hydroxyethyl(meth)acrylate or having an epoxy group, for example, such as the compounds described in the formula (V-1)-(V-15).

Reaction products of polymers having alcoholic hydroxy groups such as copolymers of 2-hydroxyethyl(meth)acrylate, (meth)acrylic acid, benzyl methacrylate and styrene, with (meth)acrylic acid or (meth)acryl chloride can also be used as ethylenically unsaturated compound.

Other examples are reaction products of a polyester with terminal unsaturated groups, which is obtained from the reaction of a dibasic acid anhydride and a compound having at least two epoxy groups followed by further reaction with an unsaturated compound, with a polybasic acid anhydride.

Further examples are resins obtained by the reaction of a saturated or unsaturated polybasic acid anhydride with a reaction product obtained by adding epoxy group containing (meth)acrylic compound to all of the carboxyl groups of a carboxylic acid containing polymer as mentioned above.

The ethylenically unsaturated polymerizable compound can be used alone or in any desired mixtures.

Examples of suitable photoinitiators are, camphor quinone; benzophenone, benzophenone derivatives, such as 2,4,6-trimethylbenzophenone, 2-methylbenzophenone, 3-methylbenzophenone, 4-methylbenzophenone, 2-methoxycarbonylbenzophenone, 4,4′-bis(chloromethyl)benzophenone, 4-chlorobenzophenone, 4-phenylbenzophenone, 3,3′-dimethyl-4-methoxy-benzophenone, [4-(4-methylphenylthio)phenyl]-phenylmethanone, methyl-2-benzoylbenzoate, 3-methyl-4′-phenylbenzophenone, 2,4,6-trimethyl-4′-phenylbenzophenone, 4,4′-bis(dimethylamino)benzophenone, 4,4′-bis(diethylamino)benzophenone; ketal compounds, as, for example, benzildimethylketal (IRGACURE® 651); acetophenone, acetophenone derivatives, for example α-hydroxycycloalkyl phenyl ketones or 2-hydroxy-2-methyl-1-phenylpropanone (DAROCUR® 1173), 1-hydroxy-cyclohexyl-phenyl-ketone (IRGACURE® 184), 1-[4-(2-Hydroxyethoxy)-phenyl]-2-hydroxy-2-methyl-1-propan-1-one (IRGACURE® 2959); 2-hydroxy-1-{4-[4-(2-hydroxy-2-methyl-propionyl)-benzyl]-phenyl}-2-methylpropan-1-one (IRGACURE® 127); 2-hydroxy-1-{4-[4-(2-hydroxy-2-methylpropionyl)-phenoxy]-phenyl}-2-methylpropan-1-one; dialkoxyacetophenones, α-hydroxy- or α-aminoacetophenones, e.g. (4-methylthiobenzoyl)-1-methyl-1-morpholinoethane (IRGACURE® 907), (4-morpholinobenzoyl)-1-benzyl-1-dimethylaminopropane (IRGACURE® 369), (4-morpholinobenzoyl)-1-(4-methylbenzyl)-1-dimethylaminopropane (IRGACURE® 379), (4-(2-hydroxyethyl)aminobenzoyl)-1-benzyl-1-dimethylaminopropane), (3,4-dimethoxybenzoyl)-1-benzyl-1-dimethylaminopropane; 4-aroyl-1,3-dioxolanes, benzoin alkyl ethers and benzil ketals, phenylglyoxalic esters and derivatives thereof, e.g. oxo-phenyl-acetic acid 2-(2-hydroxy-ethoxy)-ethyl ester, dimeric phenylglyoxalic esters, e.g. oxo-phenyl-acetic acid 1-methyl-2-[2-(2-oxo-2-phenyl-acetoxy)-propoxy]-ethyl ester (IRGACURE® 754); further oximeesters, e.g. 1,2-octanedione 1-[4-(phenylthio)phenyl]-2-(O-benzoyloxime) (IRGACURE® OXE01), ethanone 1-[9-ethyl-6-(2-methylbenzoyl)-9H-carbazol-3-yl]-1-(O-acetyloxime) (IRGACURE® OXE02), 9H-thioxanthene-2-carboxaldehyde 9-oxo-2-(O-acetyloxime), peresters, e.g. benzophenone tetracarboxylic peresters as described for example in EP 126541, monoacyl phosphine oxides, e.g. (2,4,6-trimethylbenzoyl)diphenylphosphine oxide (DAROCUR® TPO), bisacylphosphine oxides, e.g. bis(2,6-dimethoxy-benzoyl)-(2,4,4-trimethyl-pentyl)phosphine oxide, bis(2,4,6-trimethylbenzoyl)-phenylphosphine oxide (IRGACURE® 819), bis(2,4,6-trimethylbenzoyl)-2,4-dipentoxyphenylphosphine oxide, trisacylphosphine oxides, halomethyltriazines, e.g. 2-[2-(4-methoxy-phenyl)-vinyl]-4,6-bis-trichloromethyl-[1,3,5]-triazine, 2-(4-methoxy-phenyl)-4,6-bis- trichloromethyl-[1,3,5]-triazine, 2-(3,4-dimethoxy-phenyl)-4,6-bis-trichloromethyl-[1,3,5]-triazine, 2-methyl-4,6-bis-trichloromethyl-[1,3,5]-triazine, hexaarylbisimidazole/coinitiators systems, e.g. ortho-chlorohexaphenyl-bisimidazole combined with 2-mercaptobenzthiazole, and 4,4′-bis(diethylamino)benzophenone ferrocenium compounds, or titanocenes, e.g. bis(cyclopentadienyl)-bis(2,6-difluoro-3-pyrryl-phenyl)titanium (IRGACURE® 784). Further, borate compounds can be used as coinitiators.

Where the photoinitiator systems are employed in hybrid systems, use is made, in addition to the novel free-radical hardeners, of cationic photoinitiators, of peroxide compounds, such as benzoyl peroxide (other suitable peroxides are described in U.S. Pat. No. 4,950,581, column 19, lines 17-25), of aromatic sulfonium-, phosphonium- or iodonium salts as described for example in U.S. Pat. No. 4,950,581, column 18, line 60 to column 19, line 10 or cyclopentadienyl-arene-iron(II) complex salts, for example (η⁶-iso-propylbenzene)(η⁵-cyclopentadienyl)iron(II) hexafluorophosphate, as well as oxime sulfonic acid esters, as are, for example described in EP 780729. Also pyridinium and (iso)quinolinium salts as described e.g. in EP 497531 and EP 441232 may be used in combination with the photoinitiators.

The content of the photoinitiators is preferably from 0.01 to 10% by weight, preferably from 0.05 to 8% by weight, and more preferably from 1 to 5% by weight, based on the solid content of the mixture, i.e. the amount of all components without the solvent(s).

In addition to the photoinitiator the polymerizable mixtures may include various additives. Examples of these are thermal inhibitors, which are intended to prevent premature polymerization, examples being hydroquinone, hydroquinone derivatives, p-methoxyphenol, β-naphthol or sterically hindered phenols, such as 2,6-di-tert-butyl-p-cresol. In order to increase the stability on storage in the dark it is possible, for example, to use copper compounds, such as copper naphthenate, stearate or octoate, phosphorus compounds, for example triphenylphosphine, tributylphosphine, triethyl phosphite, triphenyl phosphite or tribenzyl phosphite, quaternary ammonium compounds, for example tetramethylammonium chloride or trimethylbenzylammonium chloride, or hydroxylamine derivatives, for example N-diethylhydroxylamine. To exclude atmospheric oxygen during the polymerization it is possible to add paraffin or similar wax-like substances which, being of inadequate solubility in the polymer, migrate to the surface in the beginning of polymerization and form a transparent surface layer which prevents the ingress of air. It is also possible to apply an oxygen-impermeable layer on top of the coating, for example poly(vinylalcohol-co-vinylacetate). Light stabilizers which can be added in a small quantity are UV absorbers, for example those of the hydroxyphenylbenzotriazole, hydroxyphenyl benzophenone, oxalamide or hydroxyphenyl-s-triazine type. These compounds can be used individually or in mixtures, with or without sterically hindered amines (HALS).

Examples of such UV absorbers and light stabilizers are, for example, the following:

### 1. 2-(2′-Hydroxyphenyl)benzotriazoles

for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotrizole, 2-(2′-hydroxy-4′-octoxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)-benzotriazole, mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethyl-hexyl-oxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-yl-phenol]; transesterification product of 2-[3′-tert-butyl-5′-(2-methoxycarbonylethyl)-2′-hydroxy-phenyl]-benzotriazole with polyethylene glycol 300; [R-CH₂CH₂—COO(CH₂)₃]₂—, where R=3′-tert-butyl-4′-hydroxy-5′-2H-benzotriazol-2-yl-phenyl.

### 2. 2-Hydroxybenzophenones

for example the 4-hydroxy-, 4-methoxy-, 4-octoxy-, 4-decyloxy-, 4-dodecyloxy-, 4-benzyloxy-, 4,2′,4′-trihydroxy- and 2′-hydroxy-4,4′-dimethoxy derivative.

### 3. Esters of Substituted or Unsubstituted Benzoic Acids

for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, and 2-methyl-4,6-di-tert-butylphenyl 3,5-d i-tert-butyl-4-hydroxybenzoate.

### 4. Acrylates

for example isooctyl or ethyl α-cyano-β,β-diphenyl acrylate, methyl α-carbomethoxycinnamate, butyl or methyl α-cyano-β-methyl-p-methoxycinnamate, methyl α-carbomethoxy-p-methoxycinnamate and N-(β-carbomethoxy-β-cyanovinyl)-2-methylindoline.

### 5. Sterically Hindered Amines

for example bis-(2,2,6,6-tetramethylpiperidyl) sebacate, bis-(2,2,6,6-tetramethylpiperidyl)succinate, bis-(1,2,2,6,6-pentamethylpiperidyl)sebacate, bis(1,2,2,6,6-pentamethylpiperidyl)n-butyl-3,5-di-tert-butyl-4-hydroxybenzylmalonate, condensation product of 1-hydroxyethyl-2,2,6,6-tetramethyl-4-hydroxypiperidine and succinic acid, condensation product of N,N′-bis-(2,2,6,6-tetramethyl-4-piperidyl)hexamethylenediamine and 4-tert-octylamino-2,6-dichloro-1,3,5-s-triazine, tris-(2,2,6,6-tetramethyl-4-piperidyl)nitrilotriacetate, tetrakis-(2,2,6,6-tetramethyl-4-piperidyl)-1,2,3,4-butane tetraoate, 1,1′-(1,2-ethandiyl)bis(3,3,5,5-tetramethylpiperazinone), 4-benzoyl-2,2,6,6-tetramethylpiperidine, 4-stearyloxy-2,2,6,6-tetramethylpiperidine, bis-(1,2,2,6,6-pentamethylpiperidyl) 2-n-butyl-2-(2-hydroxy-3,5-di-tert-butylbenzyl)malonate, 3-n-octyl-7,7,9,9-tetramethyl-1,3,8-triazaspiro-[4.5]decane-2,4-dione, bis-(1-octyloxy-2,2,6,6-tetramethylpiperidyl)sebacate, bis-(1-octyloxy-2,2,6,6-tetramethylpiperidyl)succinate, condensation product of N,N′-bis-(2,2,6,6-tetramethyl-4-piperidyl)hexamethylenediamine and 4-morpholino-2,6-dichloro-1,3,5-triazine, condensation product of 2-chloro-4,6-di-(4-n-butylamino-2,2,6,6-tetramethylpiperidyl)-1,3,5-triazine and 1,2-bis-(3-aminopropyl-amino)ethane, condensation product of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione and 3-dodecyl-1-(1,2,2,6,6-pentamethyl-4-piperidyl)-pyrrolidine-2,5-dione.

### 6. Oxalamides

for example 4,4′-dioctyloxyoxanilide, 2,2′-diethoxyoxanilide, 2,2′-dioctyloxy-5,5′-di-tert-butyloxanilide, 2,2′-didodecyloxy-5,5′di-tert-butyloxanilide, 2-ethoxy-2′-ethyl-oxanilide, N,N′-bis-(3-dimethylaminopropyl)oxalamide, 2-ethoxy-5-tert-butyl-2′-ethyloxanilide and its mixture with 2-ethoxy-2′-ethyl-5,4′-di-tert-butyloxanilide, mixtures of o- and p-methoxy- and of o- and p-ethoxy-disubstituted oxanilides.

### 7. 2-(2-Hydroxyphenyl)-1,3,5-triazines

for example 2,4,6-tris(2-hydroxy-4-octyloxyphenyl)-1,3,5-triazine, 2-(2-hydroxy-4-octyloxyphenyl)-4,6-bis-(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxy-phenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxy-propyloxy)phenyl]-4,6-bis(2,4-dimethylphenyl)-1,3,5-triazine, 2-[2-hydroxy-4-(2-hydroxy-3-octyloxy-propyloxy)phenyl]-4,6-bis(2,4-dimethylphenyl)-1,3,5-triazine, 2-[4-dodecyl/tridecyl-oxy-(2-hydroxypropyl)oxy-2-hydroxy-phenyl]-4,6-bis(2,4-dimethylphenyl)-1,3,5-triazine.

### 8. Phosphites and Phosphonites

for example triphenyl phosphite, diphenyl alkyl phosphites, phenyl dialkyl phosphites, tris(nonylphenyl)phosphite, trilauryl phosphite, trioctadecyl phosphite, distearyl pentaerythrityl diphosphite, tris-(2,4-di-tert-butylphenyl)phosphite, diisodecyl pentaerythrityl diphosphite, bis-(2,4-di-tert-butylphenyl)pentaerythrityl diphosphite, bis-(2,6-di-tert-butyl-4-methylphenyl)pentaerythrityl diphosphite, bis-isodecyloxy pentaerythrityl diphosphite, bis-(2,4-di-tert-butyl-6-methylphenyl)pentaerythrityl diphosphite, bis-(2,4,6-tri-tert-butylphenyl)pentaerythrityl diphosphite, tristearyl sorbityl triphosphite, tetrakis-(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyl-dibenzo[d,g]-1,3,2-dioxaphosphocine, bis-(2,4-di-tert-butyl-6-methylphenyl)methyl phosphite and bis(2,4-di-tert-butyl-6-methylphenyl)ethyl phosphite.

To accelerate the photopolymerization it is possible to further add amines, for example triethanolamine, N-methyldiethanolamine, ethyl-p-dimethylaminobenzoate, 2-(dimethylamino)ethyl benzoate, 2-ethylhexyl-p-dimethylaminobenzoate, octyl-para-N,N-dimethylaminobenzoate, N-(2-hydroxyethyl)-N-methyl-para-toluidine or Michler's ketone. The action of the amines can be intensified by the addition of aromatic ketones of the benzophenone type. Examples of amines which can be used as oxygen scavengers are substituted N,N-dialkylanilines, as are described in EP 339841. Other accelerators, coinitiators and autoxidizers are thiols, thioethers, disulfides, phosphonium salts, phosphine oxides or phosphines, as described, for example, in EP 438123, in GB 2180358 and in JP Kokai Hei 6-68309.

It is further possible to add chain transfer agents which are customary in the art to the polymerizable mixture according to the invention. Examples are mercaptans, amines and benzothiazol.

Photopolymerization can also be accelerated by adding further photosensitizers or coinitiators which shift or broaden the spectral sensitivity. These are, in particular, aromatic compounds, for example benzophenone and derivatives thereof, thioxanthone and derivatives thereof, anthraquinone and derivatives thereof, coumarin and phenothiazine and derivatives thereof, and also 3-(aroylmethylene)thiazolines, rhodamine, camphorquinone, but also eosine, rhodamine, erythrosine, xanthene, thioxanthene, acridine, e.g. 9-phenylacridine, 1,7-bis(9-acridinyl)heptane, 1,5-bis(9-acridinyl)pentane, cyanine and merocyanine dyes.

Specific examples of such compounds are, for example, the following:

### 1. Thioxanthones

Thioxanthone, 2-isopropylthioxanthone, 2-chlorothioxanthone, 1-chloro-4-propoxythioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di-[2-(2-methoxyethoxy)ethoxycarbonyl]-thioxanthone, 1,3-dimethyl-2-hydroxy-9H-thioxanthen-9-one 2-ethylhexylether, 1-ethoxycarbonyl-3-(1-methyl-1-morpholinoethyl)-thioxanthone, 2-methyl-6-dimethoxymethylthioxanthone, 2-methyl-6-(1,1-dimethoxybenzyl)-thioxanthone, 2-morpholinomethylthioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 1-phenoxythioxanthone, 6-ethoxycarbonyl-2-methoxythioxanthone, 6-ethoxycarbonyl-2-methylthioxanthone, thioxanthone-2-carboxylic acid polyethyleneglycol ester, 2-hydroxy-3-(3,4-dimethyl-9-oxo-9H-thioxanthon-2-yloxy)-N,N,N-trimethyl-1-propaneammonium chloride.

### 2. Benzophenones

Benzophenone, 4-phenyl benzophenone, 4-methoxy benzophenone, 4,4′-dimethoxy benzophenone, 4,4′-dimethyl benzophenone, 4,4′-dichlorobenzophenone, 4,4′-bis(dimethylamino)benzophenone, 4,4′-bis(diethylamino)benzophenone, 4,4′-bis(methylethylamino)benzophenone, 4,4′-bis(p-isopropylphenoxy)benzophenone, 4-methyl benzophenone, 2,4,6-trimethylbenzophenone, 4-(4-methylthiophenyl)-benzophenone, 3,3′-dimethyl-4-methoxy benzophenone, methyl-2-benzoylbenzoate, 4-(2-hydroxyethylthio)-benzophenone, 4-(4-tolylthio)benzophenone, 144-(4-benzoyl-phenylsulfanyl)-phenyl]-2-methyl-2-(toluene-4-sulfonyl)-propane-1-one, 4-benzoyl-N,N,N-trimethylbenzenemethaneammonium chloride, 2-hydroxy-3-(4-benzoylphenoxy)-N,N,N-trimethyl-1-propaneammonium chloride monohydrate, 4-(13-acryloyl-1,4,7,10,13-pentaoxatridecyl)-benzophenone, 4-benzoyl-N,N-dimethyl-N-[2-(1-oxo-2-propenyl)oxy]ethyl-benzenemethaneammonium chloride.

### 3. Coumarins

Coumarin 1, Coumarin 2, Coumarin 6, Coumarin 7, Coumarin 30, Coumarin 102, Coumarin 106, Coumarin 138, Coumarin 152, Coumarin 153, Coumarin 307, Coumarin 314, Coumarin 314T, Coumarin 334, Coumarin 337, Coumarin 500, 3-benzoyl coumarin, 3-benzoyl-7-methoxycoumarin, 3-benzoyl-5,7-dimethoxycoumarin, 3-benzoyl-5,7-dipropoxycoumarin, 3-benzoyl-6,8-dichlorocoumarin, 3-benzoyl-6-chloro-coumarin, 3,3′-carbonyl-bis[5,7-di(propoxy)-coumarin], 3,3′-carbonyl-bis(7-methoxycoumarin), 3,3′-carbonyl-bis(7-diethylamino-coumarin), 3-isobutyroylcoumarin, 3-benzoyl-5,7-dimethoxy-coumarin, 3-benzoyl-5,7-diethoxy-coumarin, 3-benzoyl-5,7-dibutoxycoumarin, 3-benzoyl-5,7-di(methoxyethoxy)-coumarin, 3-benzoyl-5,7-di(allyloxy)coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl)-coumarin, 5,7-diethoxy-3-(1-naphthoyl)-coumarin, 3-benzoylbenzo[f]coumarin, 7-diethylamino-3-thienoylcoumarin, 3-(4-cyanobenzoyl)-5,7-dimethoxycoumarin, 3-(4-cyanobenzoyl)-5,7-dipropoxycoumarin, 7-dimethylamino-3-phenylcoumarin, 7-diethylamino-3-phenylcoumarin, the coumarin derivatives disclosed in JP 09-179299-A and JP 09-325209-A, for example 7-[{4-chloro-6-(diethylamino)-s-triazine-2-yl}amino]-3-phenylcoumarin.

### 4. 3-(Aroylmethylene)-thiazolines

3-Methyl-2-benzoylmethylene-β-naphthothiazoline, 3-methyl-2-benzoylmethylene-benzothiazoline, 3-ethyl-2-propionylmethylene-β-naphthothiazoline.

### 5. Rhodamines

4-Dimethylaminobenzalrhodamine, 4-diethylaminobenzalrhodamine, 3-ethyl-5-(3-octyl-2-benzothiazolinylidene)-rhodamine, the rhodamine derivatives, formulae [1], [2], [7], disclosed in JP 08-305019A.

### 6. Other Compounds

Acetophenone, 3-methoxyacetophenone, 4-phenylacetophenone, benzil, 4,4′-bis(dimethylamino)benzil, 2-acetylnaphthalene, 2-naphthaldehyde, dansyl acid derivatives, 9,10-anthraquinone, anthracene, pyrene, aminopyrene, perylene, phenanthrene, phenanthrenequinone, 9-fluorenone, dibenzosuberone, curcumin, xanthone, thiomichler's ketone, α-(4-dimethylaminobenzylidene) ketones, e.g. 2,5-bis(4-diethylaminobenzylidene)cyclopentanone, 2-(4-dimethylamino-benzylidene)-indan-1-one, 3-(4-dimethylamino-phenyl)-1-indan-5-yl-propenone, 3-phenylthiophthalimide, N-methyl-3,5-di(ethylthio)-phthalimide, N-methyl-3,5-di(ethylthio)-phthalimide, phenothiazine, methylphenothiazine, amines, e.g. N-phenylglycine, ethyl 4-dimethylaminobenzoate, butoxyethyl 4-dimethylaminobenzoate, 4-dimethylaminoacetophenone, triethanolamine, methyldiethanolamine, dimethylaminoethanol, 2-(dimethylamino)ethyl benzoate, poly(propylenegylcol)-4-(dimethylamino)benzoate.

A photopolymerizable mixture, comprising as further additive a photosensitizer compound selected from the group consisting of benzophenone and its derivatives, thioxanthone and its derivatives, anthraquinone and its derivatives, or coumarin derivatives, is preferred.

The photopolymerization can be assisted by adding photosensitizers and also by adding a component which under thermal conditions forms free radicals, for example an azo compound such as 2,2′-azobis(4-methoxy-2,4-dimethylvaleronitrile), a triazene, diazo sulfide, pentazadiene or a peroxy compound, for instance a hydroperoxide or peroxycarbonate, for example t-butyl hydroperoxide, as described, for example, in EP 245639.

The polymerizable color filter mixture may comprise as further additive a photoreducable dye, e.g., xanthene, benzoxanthene, benzothioxanthene, thiazine, pyronine, porphyrine or acridine dyes, and/or trihalogenmethyl compounds which can be cleaved by irradiation.

Further additives known in the art may be added, for example flow improvers, adhesion promoters, such as vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane and 3-mercaptopropyltrimethoxysilane. Surfactants, optical brighteners, pigments, dyes, wetting agents, levelling assistants, dispersants, aggregation preventers, antioxidants or fillers are further examples for suitable additives.

In order to cure thick and colored coatings it is appropriate to add glass microspheres or pulverized glass fibres, as described, for example, in U.S. Pat. No. 5,013,768.

The choice of additive(s) is made depending on the field of application and on properties required for this field. The additives described above are customary in the art and accordingly are added in amounts which are usual in the respective application.

Further, in the color filter the total solid component of each color may contain an ionic impurity scavenger, e.g. an organic compound having an epoxy group. The amount of the ionic impurity scavenger is generally in the range of from 0.1 to 10% by weight.

The mixture according to this invention can comprise additionally a crosslinking agent which is activated by an acid, for example as described in JP 10-221843-A, and a compound which generates acid thermally or by actinic radiation and which activates a crosslinking reaction.

The mixture according to this invention can also comprise latent pigments which are transformed into finely dispersed pigments during the heat treatment of the latent pigment containing photosensitive pattern or coating. The heat treatment can be performed after exposure or after development of the latent pigment-containing photoimageable layer. Such latent pigments are soluble pigment precursors which can be transformed into insoluble pigments by means of chemical, thermal, photolytic or radiation induced methods as described, for example, in U.S. Pat. No. 5,879,855. This transformation of such latent pigments can be enhanced by adding a compound which generates acid at actinic exposure or by adding an acidic compound to the composition. Therefore, a color filter resist can also be prepared, which comprises a latent pigment in a mixture according to this invention.

Examples for color filter resists, the mixture of such resists and the processing conditions are given by T. Kudo et al., Jpn. J. Appl. Phys. Vol. 37 (1998) 3594; T. Kudo et al., J. Photopolym. Sci. Technol. Vol 9 (1996) 109; K. Kobayashi, Solid State Technol. November 1992, p. S15-S18; U.S. Pat. No. 5,368,976; U.S. Pat. No. 5,800,952; U.S. Pat. No. 5,882,843; U.S. Pat. No. 5,879,855; U.S. Pat. No. 5,866,298; U.S. Pat. No. 5,863,678; JP 06-230212-A; EP 320264; JP 09-269410-A; JP 10-221843-A; JP 01-090516-A; JP 10-171119-A, U.S. Pat. No. 5,821,016, U.S. Pat. No. 5,847,015, U.S. Pat. No. 5,882,843, U.S. Pat. No. 5,719,008, EP 881541, or EP 902327.

It is understood by a person skilled in the art that the use of the colorant nanoparticles of the present invention is not limited to the specific binder resins, photoinitiators, crosslinkers and formulations of the color filter resist examples given hereinbefore but can be used in conjunction with any polymerizable component in combination with a dye or color pigment or latent pigment to form a photosensitive color filter ink or color filter resist.

It is well known in the art that a primary particle size of colorants is preferably smaller than the wavelength of transparent region of the color filters in order not to lose transparency due to scattering of light. The surface-modified nanoparticles described hereinbefore have generally a primary particle size of less than 500 nm, preferably less than 100 nm, more preferably less than 50 nm and most preferably less than 25. The same applies to the particle size distribution of the pigments of the main colorant.

Micronisation techniques in obtaining such small particles have been known in the industry, for example, various milling method with/without inorganic salt such as dry milling, wet milling, roll milling, ball milling, beads milling, sand milling, Henschel milling, pin milling, dispersion milling and salt kneading. Fine particles of the surface-modified nanoparticles described hereinbefore can be obtained directly by controlling the synthesis conditions, e.g. temperature and pH control of the deprotonation conditions. All these techniques are applicable in obtaining fine particles of the surface-modified nanoparticles described hereinbefore.

Preferably, fine particles of the surface-modified nanoparticles are obtained (i) by controlling the deprotection condition to give fine particles, or (ii) salt kneading of crude surface-modified nanoparticles.

Optionally a surface treatment is applied to the colored nanoparticles in order to make the colorants easy to disperse and to stabilize the resultant colorant dispersion. The surface treatment reagents are, for example, surfactants, polymeric dispersants, general texture improving agents, pigment derivatives and mixtures thereof. It is especially preferred when the colorant polymerizable mixture according to the invention comprises at least one polymeric dispersant and/or at least pigment derivative.

Such additives may generally be used in an amount from 0.1 to 50% by weight, preferably 0.1 to 30% by weight, based on the total solids of the polymerizable mixture, i.e. the amount of all components without the solvent(s).

Polymeric dispersants act via a steric stabilization mechanism on the basis of its two-component structure which combines the following two very different requirements: (1) it is capable of being strongly adsorbed into the pigment surface and thereby possesses specific anchoring groups and (2) it contains polymeric chains that give steric stabilization in the required solvent or resin solution system.

Polymeric dispersants differentiate themselves from the other types of dispersing agents through considerably higher molecular weights. Because of its structural features, a polymeric dispersant is bound to numerous sites at the same time, forming durable adsorption layers upon many pigment particles. Optimal steric stabilization is achieved when the polymer chains are well solvated and properly unfurled, therefore they must be highly compatible with the surrounding resin solution. If this compatibility is obstructed, the polymer chains collapse causing the steric hindrance and the resulting stabilization to be lost.

Suitable polymeric dispersants improve dispersion of the colored nanoparticles and reduce interparticulate attraction within that dispersion. The improved dispersion means a small average particle size (or particle size reduction achieved in a shorter milling time) with a narrower particle size distribution. Smaller particles are generally more prone to re-agglomeration or flocculation; however, because of the reduction in inter-particulate attraction, this is not the case with the dispersants according to the instant invention. Dispersions are significantly more stable to flocculation and agglomeration than those produced by conventional means.

As already noted above, suitable polymeric dispersants possess a two-component structure comprising a polymeric chain and an anchoring group. The particular combination of these leads to their effectiveness.

Suitable surfactants include anionic surfactants such as alkylbenzene- or alkylnaphthalene-sulfonates, alkylsulfosuccinates or naphthalene formaldehyde sulfonates; cationic surfactants including, for example, quaternary salts such as benzyl tributyl ammonium chloride; or nonionic or amphoteric surfactants such as polyoxyethylene surfactants and alkyl- or amidopropyl betaines, respectively.

Illustrative examples of the surfactant include polyoxyethylene alkyl ethers such as polyoxyethylene lauryl ether, polyoxyethylene stearyl ether and polyoxyethylene oleyl ether; polyoxyethylene alkylphenyl ethers such as polyoxyethylene octylphenyl ether and polyoxyethylene nonylphenyl ether; polyethylene glycol diesters such as polyethylene glycol dilaurate and polyethylene glycol distearate; sorbitan fatty acid esters; fatty acid modified polyesters; tertiary amine modified polyurethanes; polyethyleneimines; those available under the trade names of KP (a product of Shin-Etsu Chemical Co., Ltd), Polyflow (a product of KYOEISHA CHEMICAL Co., Ltd), F-Top (a product of Tochem Products Co., Ltd), MEGAFAC (a product of Dainippon Ink & Chemicals, Inc.), Fluorad (a product of Sumitomo 3M Ltd), Asahi Guard and Surflon (products of Asahi Glass Co., Ltd); and the like.

These surfactants may be used alone or in admixture of two or more.

Suitable polymeric dispersants are, for example, BYK's Disperbyk® 101, 115, 130, 140, 160, 161, 162, 163, 164, 166, 168, 169, 170, 171, 180, 182, 2000, 2001, 2050, 2090, 2091, 2095, 2096, 2150, EFKA Additives' EFKA® 4008, 4009, 4010, 4015, 4046, 4047, 4050, 4055, 4060, 4080, 4300, 4330, 4400, 4401, 4402, 4403, 4406, 4500, 4510, 4520, 4530, 4540, 4550, 4560, Ajinomoto Fine Techno's PB® 711, 821, 822, 823, 824, 827, Lubrizol's Solsperse® 1320, 13940, 17000, 20000, 21000, 24000, 26000, 27000, 28000, 31845, 32500, 32550, 32600, 33500, 34750, 36000, 36600, 37500, 39000, 41090, 44000, 53095, ALBRITECT® CP30 (a copolymer of acrylic acid and acrylphosphonate) and combinations thereof.

It is preferred to use EFKA® 4046, 4047, 4060, 4300, 4330, 8512, Disperbyk® 161, 162, 163, 164, 165, 166, 168, 169, 170, 2000, 2001, 2050, 2090, 2091, 2095, 2096, 2105, 2150, PB® 711, 821, 822, 823, 824, 827, Solsperse® 24000, 31845, 32500, 32550, 32600, 33500, 34750, 36000, 36600, 37500, 39000, 41090, 44000, 53095, ALBRITECT® CP30 and combinations thereof as dispersant.

Suitable texture improving agents are, for example, fatty acids such as stearic acid or behenic acid, and fatty amines such as laurylamine and stearylamine. In addition, fatty alcohols or ethoxylated fatty alcohols, polyols such as aliphatic 1,2-diols or epoxidized soy bean oil, waxes, resin acids and resin acid salts may be used for this purpose.

Suitable pigment derivatives are, for example, copper phthalocyanine derivatives such as EFKA Additives' EFKA 6745, Lubrizol's Solsperse 5000, 12000, BYK's Synergist 2100 and azo derivatives such as EFKA 6750, Solsperse 22000 and Synergist 2105.

These surface treatment reagents can be preferably applied to the above-mentioned micronisation process for effective treatment.

Color filters according to the present invention are generally prepared by providing red, green and blue (RGB) color elements and, optionally a black matrix, all comprising a polymerizable mixture and a colored nanoparticle on a transparent substrate and providing a transparent electrode either on the surface of the substrate or on the surface of the color filter layer, wherein said polymerizable mixture comprises a polyfunctional acrylate monomer, a binder and a colored nanoparticle as described above. The monomer and binder components, as well as suitable colorants are as described above. In the manufacture of color filters the transparent electrode layer can either be applied on the surface of the transparent substrate or can be provided on the surface of the red, green and blue picture elements and the black matrix. The transparent substrate is, for example, a glass substrate, which can additionally have an electrode layer on its surface.

It is preferred to apply a black matrix between the color areas of different color in order to improve the contrast of a color filter.

Instead of forming a black matrix using a photosensitive composition and patterning the black photosensitive composition photolithographically by patternwise exposure (i.e. through a suitable mask) to form the black pattern separating the red, green and blue colored areas on the transparent substrate it is alternatively possible to use an inorganic black matrix. Such inorganic black matrix can be formed from deposited (i.e. sputtered) metal (i.e. chromium) film on the transparent substrate by a suitable imaging process, for example utilizing photolithographic patterning by means of an etch resist, etching the inorganic layer in the areas not protected by the etch resist and then removing the remaining etch resist.

There are different methods known how and at which step in the color filter manufacturing process the black matrix can be applied. It can either be applied directly on the transparent substrate prior to formation of the red, green and blue (RGB) color filter as already mentioned above, or it can be applied after the RGB color filter is formed on the substrate.

In a different embodiment of a color filter for a liquid crystal display, according to U.S. Pat. No. 5,626,796, the black matrix can also be applied on the substrate opposite to the RGB color filter element-carrying substrate, which is separated from the former by a liquid crystal layer.

If the transparent electrode layer is deposited after applying the RGB color filter elements and—optionally—the black matrix, an additional overcoat film as a protective layer can be applied on the color filter layer prior to deposition of the electrode layer, for example, as described in U.S. Pat. No. 5,650,263.

The inventive polymerizable color filter mixture can be used for generating color pixels, for the manufacture of a color filter, regardless of the above-described differences in processing, regardless, of additional layers, which can be applied and regardless of differences in the design of the color filter. The use of a mixture according to the present invention to form colored elements shall not be regarded as limited by different designs and manufacturing processes of such color filters.

Suitable light sources are known per se from the different fields of cathode ray or neon tubes, for example as P1 (see Mori, Kakitani, Miyake, Yamaguchi, Okayama University of Science, Japan, Okayama Rika Daigaku Kiyo A 1994, 30A, 115-120) with a maximum visible luminescence intensity around 530 nm. Suitable light sources may in particular comprise Zn₂SiO₄: Mn as luminescence source, which might be powered for example by UV light or by bombardment with electrons. However, the skilled artisan will obviously also try light sources having similar or better performance. In contrast, luminescent light sources hitherto used in liquid crystal displays (for example such based on La, Ce, Tb, Yb, Eu, Ho and/or Dy, like F10) have a very narrow maximum emission at a wavelength around 545 nm, with undesired narrow side emissions at 485 and 580 nm. Generally, the instant green light source will be combined with other light sources, such as each a blue and a red light source, in order the whole combination to emit white light. The prior art liquid crystal display technology and light sources used therein is well-known from many books, publications and patents; to cite just few examples see U.S. Pat. No. 6,280,890 or the prior art documents discussed above, all contents of which are incorporated in the instant application by reference, or also Colour filters for LCD's, Displays 14(2), 115-124 (1993).

The color filters according to the present invention are applicable for a display and/or image sensor application. The display application is preferably a plasma display, organic/inorganic electroluminescent display, field emission display or liquid crystal display. The image sensor application is preferably a charge coupled device or a CMOS sensor.

The inventive color filters have a high thermal, light and physical stability, which is especially improved by additional covalent bonding of UV absorbers, dispersants and/or (hindered amine) light stabilisers to the surface of the nanoparticle.

The following examples are presented for the purpose of illustration only and are not to be construed to limit the nature or scope of the instant invention in any manner whatsoever. Unless otherwise indicated, all percentages are by weight, and room temperature denotes a temperature in the range of from 20 to 25° C.

### EXAMPLES

### Example 1

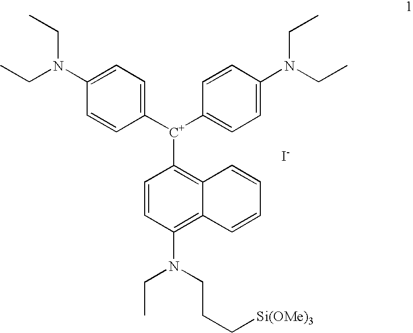

51.52 g of C.I. Basic Blue 7 (e.g. Victoria pure Blue from S&D Chemicals Ltd) are dissolved in 750 ml of distilled water, and then under stirring a 2N solution of sodium hydroxide in water is added dropwise, until the deprotonated form of the dye has completely precipitated and no blue color remains in the solution and does not come back for several hours. The precipitate is filtered off, washed with distilled and decarbonated water until the filtrate is free of chloride ions, and dried at 60° C. under an atmosphere of reduced pressure (200 mbar). 45.23 g (94.7%) of the deprotonated C.I. Basic Blue 7 are isolated as a nearly black powder.

2.0 ml (2.95 g; 10.2 mmol) of 3-iodopropyl-trimethoxysilane are added to a solution of 2.389 g (5 mmol) of deprotonated C.I. Basic Blue 7 in 50 ml of anhydrous acetonitrile, and the obtained solution is heated under an atmosphere of argon to reflux for 24 hours. Then the solvent is distilled off, and the semi-solid residue is washed several times with methyl-tert-butylether in order to remove the excess of the alkylating agent and unreacted deprotonated dye, until the filtrate is nearly colorless, avoiding the intrusion of atmospheric moisture during the procedure. Without drying, the solid residue (1) is dissolved in 50 ml of anhydrous ethanol.

### Example 2

A dispersion of 2 g of Ludox TMA (34% SiO₂ in H₂O) is diluted with 10 ml of ethanol and 0.8 g (1.35 mmol) of the material from example 1 (1) in 60 ml of ethanol/methanol (1:1 (v/v)) are added, followed by the addition of 0.8 g (2.1 mmol) of octadecyl-trimethoxysilane. The reaction mixture is stirred for 20 min at 0° C., warmed up to room temperature and stirred for 20 hours at 55° C. The dye modified silica nanoparticles are isolated after cooling to room temperature by centrifugation (2000 rpm) and decantation of the supernatant, containing the excess of the free dye. After subsequent washing with ethanol and centrifugation compound the blue solid (2) is dried in vacuo at 50° C. Yield: 1.0 g.

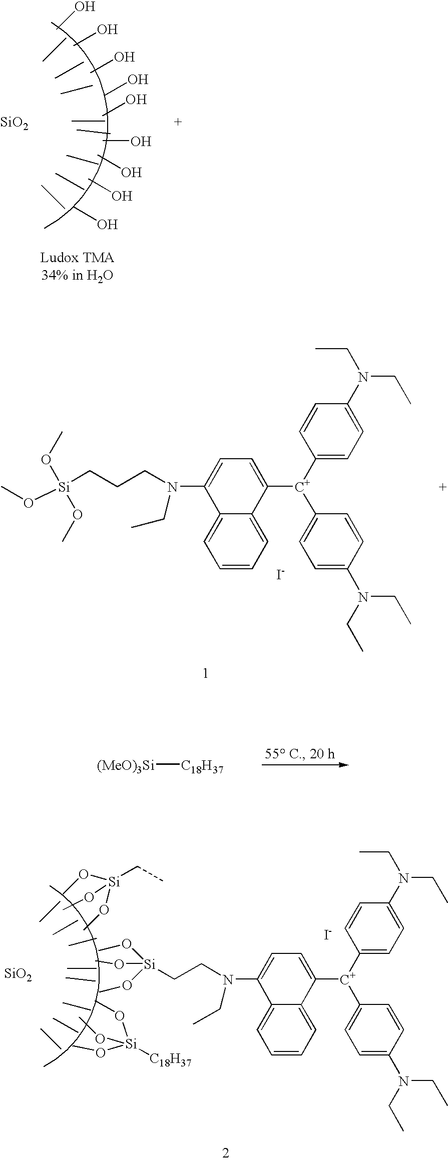

Thermographimetric analysis (TGA; heating rate: 10° C./min from 50° C. to 800° C.): Weight loss: 29.6%, corresponding to the organic material.

The thermostability of the attached dye (as measured by TGA) is approx. 100° C. higher than that of the free dye which starts to decompose at ca. 200° C.

### Example 3

Modified silica nanoparticles with “Victoria blue dye” and dispersant (poly(n-butyl acrylate) made by ATRP-technology)

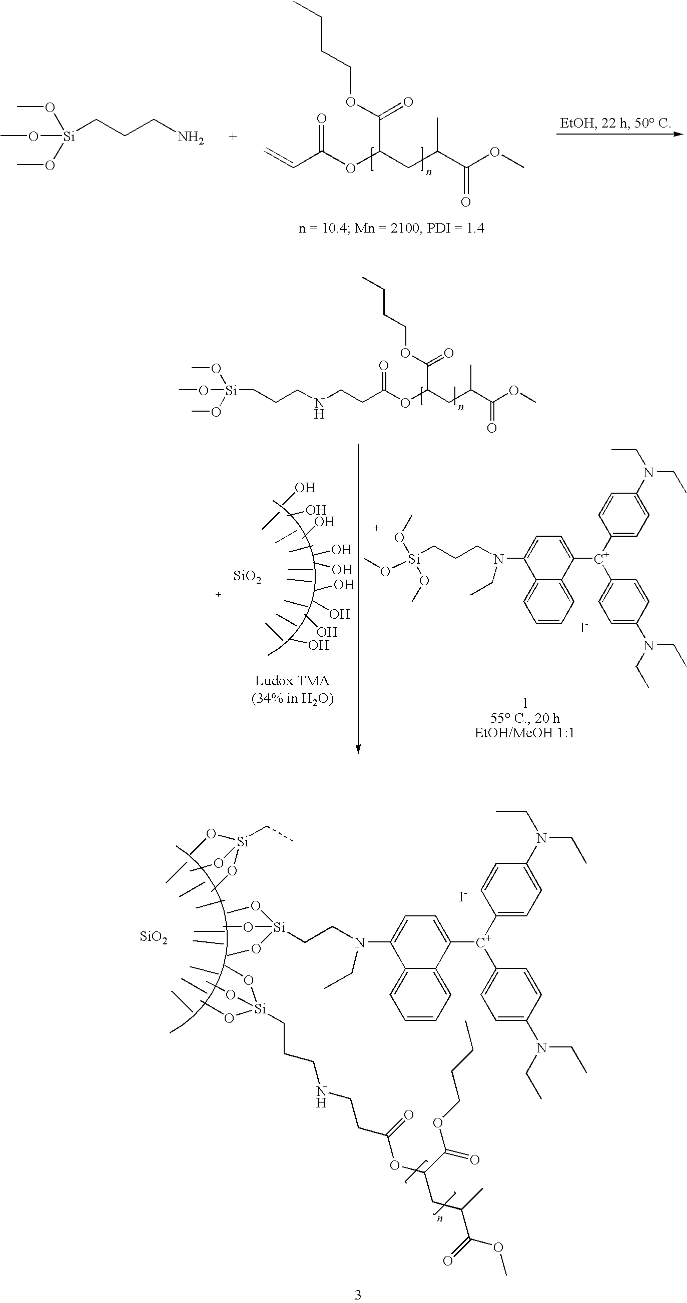

To 0.68 g (3.8 mmol) of commercial 3-aminopropyl-trimethoxysilane in 10 ml of methanol 8.0 g (3.8 mmol) of poly(n-butyl acrylate) macromonomer with acrylate end group (synthesized with ATRP technology according to A. Mühlebach, F. Rime, J. Polym. Sci., Polym. Chem. Ed. 2003, 41, 3425; Mₙ=2100, M_{w}=2940) are added and the mixture is stirred at 50° C. for 22 hours. The so formed poly(n-butyl acrylate)-trimethoxysilane is then added together with 0.8 g (1.35 mmol) of 1 (silane derivative of “Victoria Blue”) in 60 ml of ethanol/methanol (1:1 (v/v)) to a dispersion of 7.63 g of Ludox TMA (34% SiO₂ in H₂O), diluted with 40 ml of ethanol. The reaction mixture is stirred for 20 min at room temperature, followed by at 55° C. for 20 hours. The dye and dispersant modified silica nanoparticles are isolated after cooling to room temperature by centrifugation (2000 rpm) and decantation of the supernatant, containing the excess of the free dye. After subsequent washing with ethanol and centrifugation the blue solid (3) is dried in vacuo at 50° C. Yield: 10.8 g.

Thermographimetric analysis (TGA; heating rate: 10° C./min from 50° C. to 800° C.): Weight loss: 82.3% corresponding to the organic material.

Dynamic light scattering (DLS): Average diameter d=64.5 nm.

### Example 4

1 g of 2 (from example 2) is dispersed in a Skandex for 3 hours with 0.35 g of EFKA™ 4360, 3.2 g of a binder (benzyl-methacrylate-methacrylic acid-copolymer; 25% solution in propylene glycol 1-monomethyl ether 2-acetate (PGME)) and 7.6 g of PGMEA.

The resulting low viscous dispersion is spin coated on a glass substrate at 1000 rpm for 30 seconds and dried at 100° C. and postbaked at 200° C. for 5 minutes on a hot plate.
Results: A bright intensive blue filter layer with color point (standard C as a back light): x=0.143, y=0.109, Transmission is 14.5% and a contrast of around 2700. The transmission at the EBU color point (F 10 as back light) (x=0.149 and y=0.080) is about 7.5%.

### Example 5

1 g of 3 (from example 3) is dispersed in a Skandex for 3 hours with 0.35 g of EFKA™ 4360, 3.2 g of a binder (benzyl-methacrylate-methacrylic acid-copolymer; 25% solution in PGME) and 7.6 g of PGMEA.

The resulting formulation is spin coated on a glass substrate at 1000 rpm for 30 seconds and dried at 100° C.

The results are very similar to those from example 4.

### Example 6

### Comparative Example with C.I. Pigment Blue 1

0.95 g of Fanal™ Blue 6390 (BASF) is dispersed in a Skandex for 3 hours with 0.05 g of Solsperse™ 22,000 (Avecia), 1.7 g of Disperbyk™ 161 (Byk-Chemie; cationic polyurethane, dispersing agent), 10.2 g of PGMEA and 2.4 g of a binder (a benzyl-methacrylate-methacrylic acid-copolymer, 25% solution in PGMEA).

The resulting formulation is spin coated on a glass substrate at 1000 rpm for 30 seconds and dried at 100° C.

Results: x/y/Y=0.144/0.104/15.44%. Thermal stability after 5 min. at 200° C. on a hotplate: 92%. UV-Stability after 100 hours Xenon light: 75%.

### Example 7

Another route to covalently bound triaryl methanes to silica particles is described below:

### a) Synthesis of the Compound of Formula (101)

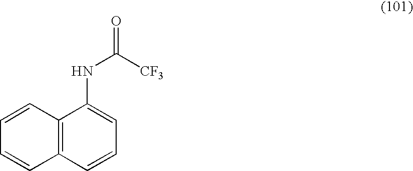

50.0 g of commercial 1-amino-naphthalene are dissolved at 0° C. in 300 ml dichloromethane and treated with 48.5 ml of triethylamine and 48.5 ml of trifluoroacetic acid anhydride. The mixture is stirred for 24 hours while warming up to room temperature. The reaction mixture is then diluted with additional dichloromethane and successively extracted with 1 N hydrochloric acid, saturated sodium hydrogen carbonate solution and brine. The organic phase is subsequently dried over magnesium sulfate, filtered and evaporated. Residual solvent is removed in high vacuum at room temperature. A slightly pink solid is obtained (81.0 g) of formula (101).

¹H-NMR (CDCl₃, 300 MHz): 7.39 (t, 1H); 7.50 (m, 2H); 7.69 (m, 3H); 7.85 (m, 1H); 8.39 (broad s, 1H).

¹³C-NMR (CDCl₃, 75 MHz): 116.30 (q); 120.41; 122.13; 125.53; 126.69; 127.20; 127.31; 128.02; 129.00; 129.41; 134.21; 156.07 (q).

¹⁹F-NMR (CDCl₃, 282 MHz): −85.

### b) Synthesis of the Compound of Formula (102)

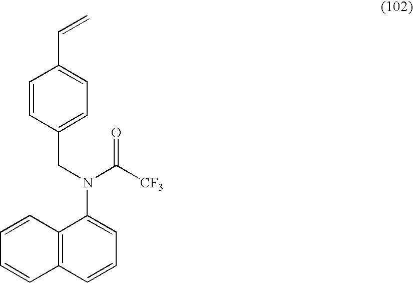

15.0 g of the compound of formula (101) are dissolved in 270 ml of dry dimethylformamide and treated with 15.0 g of a benzyl chloride derivative and 13.5 g of dry potassium carbonate at 60° C. for 17 hours. After cooling down to room temperature the mixture is diluted with ethyl acetate and successively extracted with water, 1 N hydrochloric acid and brine and dried over sodium sulfate. After filtration and evaporation of the solvent a syrupy oil is obtained which is passed over a short silica gel pad (mesh 230-400) and eluent (hexane-ethyl acetate 2:1 (v/v)) to give 32.9 g of the compound of formula (102).

¹H-NMR (CDCl₃, 300 MHz): 4.24 (d, 1H); 5.28 (dd, 1H); 5.73 (dd, 1H); 5.79 (s, 1H); 6.71 (dd, 1H); 6.95 (d, 1H); 7.12 (d, 2H); 7.32 (m, 3H); 7.59 (m, 2H); 7.82 (m, 1H); 7.91 (m, 2H).

¹³C-NMR (CDCl₃, 75 MHz): 54.57; 114.60; 122.28; 125.01; 126.58 (2C); 126.95; 127.86; 127.98; 128.60 (q); 128.93; 130.06 (2C); 130.11 (2C); 134.49; 134.69; 135.19; 136.49; 137.75; 159.00 (q).

### c) Synthesis of the Compound of Formula (103)

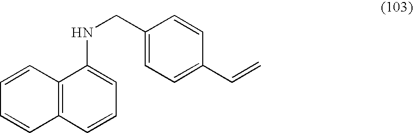

32.0 g of the compound of formula (102) are dissolved in 260 ml of a mixture of ethanol and water (3:1 (v/v)) and treated with 7.6 g of sodium hydroxide at 85° C. for one hour. After cooling down to room temperature the mixture is diluted with tert-butyl methyl ether and successively extracted with water and brine and dried over sodium sulfate. After filtration and evaporation of the solvent a syrupy mass is obtained which is passed over a short silica gel pad (mesh 230-400) and eluent (hexane/ethyl acetate 4:1 (v/v)) to give 23.6 g of the compound of formula (103).

¹H-NMR (CDCl₃, 300 MHz): 4.55 (s, 2H); 4.80 (broad s, 1H); 5.43 (dd, 1H); 5.94 (dd, 1H); 6.74 (dd, 1H); 6.88 (dd, 1H); 7.40-7.62 (m, 8H); 7.88 (d, 1H); 7.95 (dd, 1H).

¹³C-NMR (CDCl₃, 75 MHz): 48.76; 105.26; 114.17; 118.07; 120.33; 123.82; 125.12; 126.13; 126.93 (2C); 127.02; 128.19 (2C); 129.09; 134.71; 136.89; 137.13; 139.16; 143.53.

### d) Synthesis of the Substituted Victoria Blue

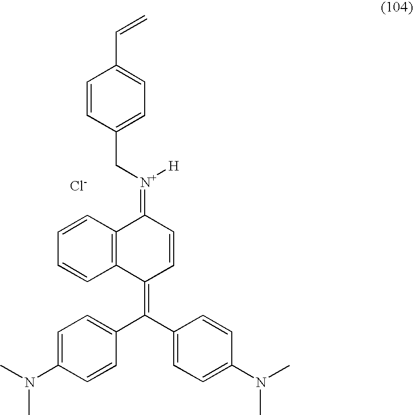

0.20 g of the neutral monomer (103) are suspended in 4 ml of dry benzene containing 0.20 g of 4,4′-bis(dimethylamino)benzophenone and 0.1 ml of phosphoroxy chloride. The mixture is heated to 85° C. for 17 hours. After cooling down to room temperature the mixture is precipitated in ethanol and centrifuged (5 times) until no benzophenone is detected by thin layer chromatography in the supernatants. The blue precipitate is then stirred in water and centrifuged from water (3 times) and finally lyophilized from dioxane to give a dark blue powder.

### e) 3-Mercaptopropylmethylsilane Modified Silica Nanoparticles

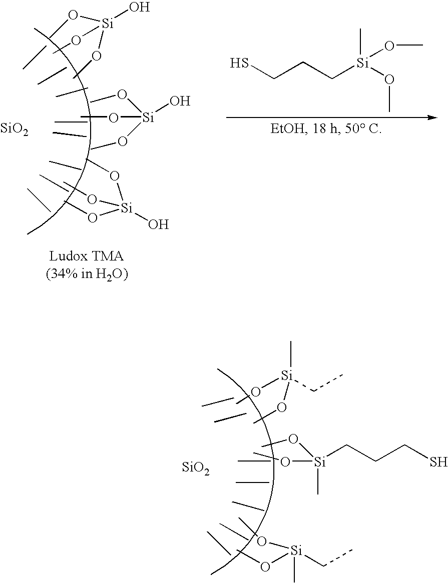

A dispersion of 100 g of Ludox TMA (34% SiO₂ in water) is mixed with 100 g of ethanol. 38 g of 3-mercaptopropylmethyldimethoxysilane dissolved in 70 g of ethanol are added dropwise to this homogeneous mixture. After the addition, the mixture is heated to 50° C. for 18 hours. The solvent of this mixture is than evaporated in the rotary evaporator and a white resin is obtained. The product is redispersed in 50 ml of ethanol and 100 g of hexane are added. The precipitated product is centrifuged at 2000 rpm for 15 min. This procedure is repeated 3 times to get rid of unreacted 3-mercaptopropylmethyldimethoxysilane. Finally, the product is redispersed in 2-propanol to obtain a 17.2 wt % dispersion.

Thermographimetric analysis (TGA; heating rate: 10° C./min from 50° C. to 600° C.): Weight loss: 18.4 wt.% corresponding to the organic material.

Elemental analysis: found: S: 5.8 wt. %: corresponding to an organic content of 17.1 wt. % (in relatively good agreement to the TGA value).

Transmission Electron Microscopy (TEM): An average diameter of 35-40 nm is obtained for the individual nanoparticles.

Dynamic light scattering (DLS): Average diameter d=38 nm.

### f) Reaction of 3-Mercaptopropylsilane Modified Silica Nanoparticles with Modified “Victoria Blue” Dye (104)

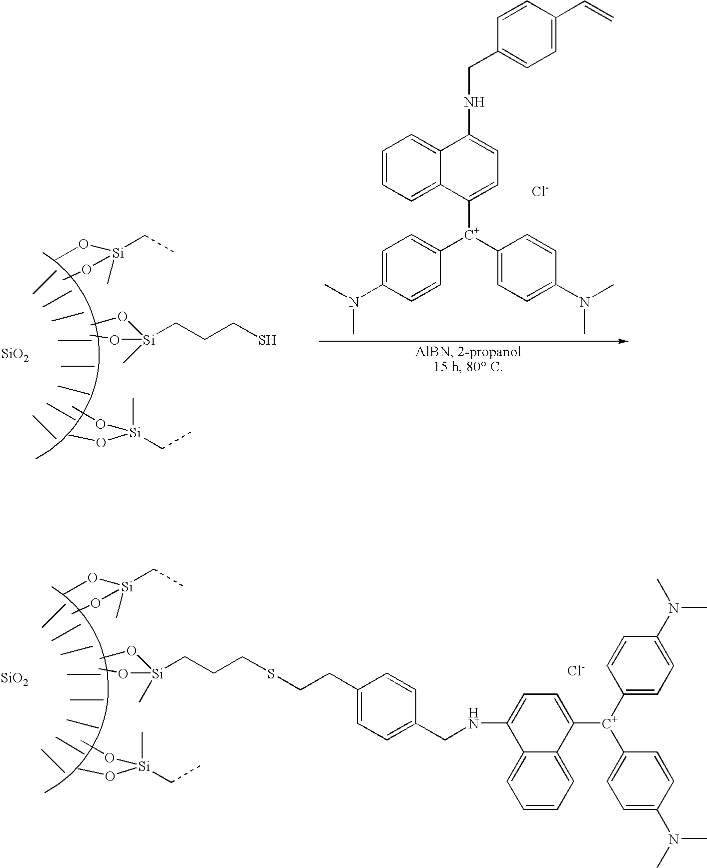

4.3 g of 3-mercaptopropylmethylsilane modified silica nanoparticles, obtainable as given above under step 7e) (1.33 mmol S) and 1.67 g (2.66 mmol) of 104 are dissolved in 50 ml of 2-propanol in a 250 ml round bottom flask and 200 mg of 2,2′-azobisisobutyronitrile (AIBN) are added. The reaction mixture is heated to 80° C. for 15 hours with stirring. The dye modified silica nanoparticles are isolated after cooling to room temperature by centrifugation (2000 rpm) and decantation of the supernatant, containing the excess of the free dye. After subsequent washing with ethanol and centrifugation the blue solid is dried in vacuo at 50° C. Yield: 4.7 g.

Thermographimetric analysis (TGA; heating rate: 10° C./min from 50° C. to 800° C.): Weight loss: 43% corresponding to the organic material.

### Example 8

### Silica/Victoria Blue/HALS

### a) Synthesis of Modified Silica Nanoparticles

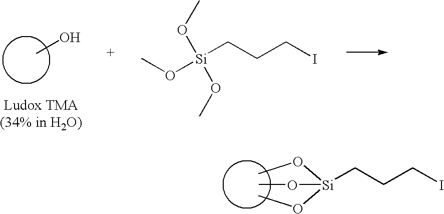

A dispersion of 15 g of Ludox TMA (34% SiO₂ in water) is diluted with 125 ml of ethanol, and 16.8 g (57.8 mmol) of 3-iodopropyltrimethoxysilane are added dropwise within 1 hour at room temperature. The mixture is stirred for 16 hours at 50° C. The DLS measurement showed a particle size of 37 nm.

### b) Deprotonation of the Dye

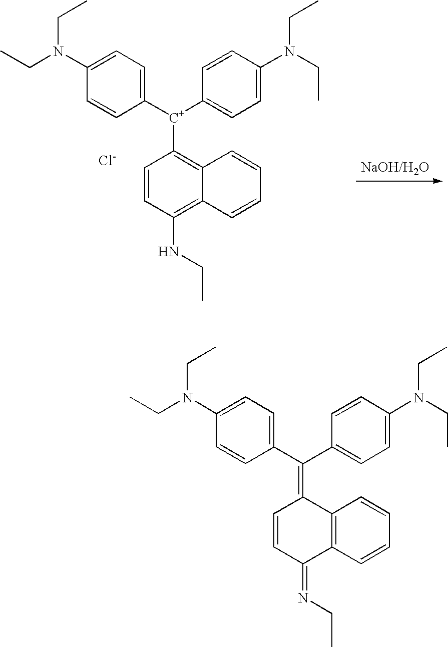

11.59 g (28.9 mmol) of Victoria Blue pure B.O. (technical grade with a chloride content of 8.85%) are dispersed in 100 ml of deionised water/ethanol (1:4 (v/v)), 28.9 ml of 1 M sodium hydroxide are added dropwise within 30 minutes at room temperature and the mixture is stirred for another hour at the same temperature. The reaction is carried out under exclusion of oxygen and carbon dioxide.

### c) Grafting of the Dye and the HALS on the Particles Surface

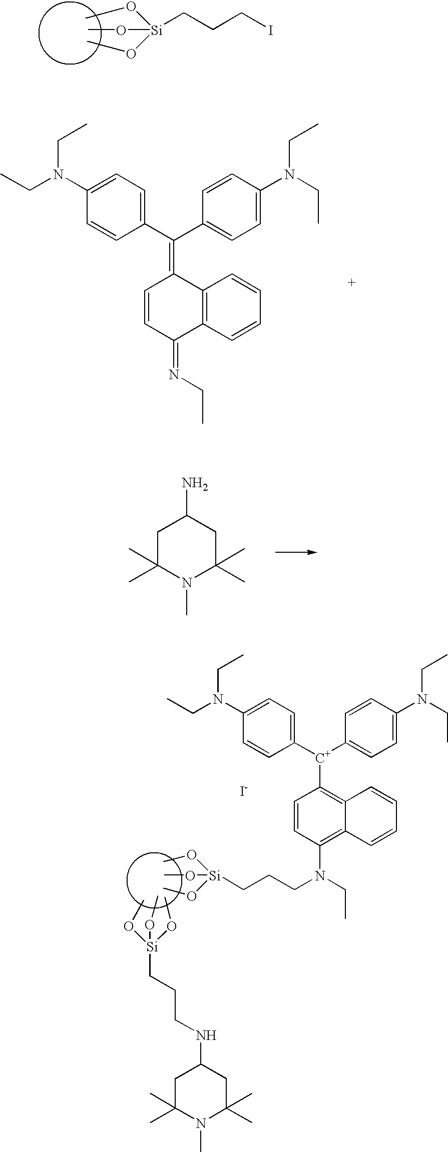

4.92 g (28.9 mmol) of 4-amino-1,2,2,6,6-pentamethyl-piperidine and another portion of 28.9 ml of 1M NaOH are added to the deprotonated dye dispersion of step b). The mixture is stirred vigorously at 50° C. The ethanolic particle dispersion of step a) is added and the mixture is heated for 5 hours at 80° C. The product is isolated by filtration and washed with deionised water. Yield: 65 g wet cake with a solid content of 40%.

Thermographimetric analysis (TGA; heating rate: 10° C./min from 50° C. to 800° C.): Weight loss: 32% corresponding to the organic material.

Anion exchange with Polyoxometallate (POM): 7.34 g of wet cake (3.23 g dried material) is ground in a mill with 200 g beads (1-1.5 mm) and 70 g of a mixture ethanol/water (1:1 (v/v)) during 8 hours. A mixture of 3.1 g of Na₂WO₄×2H₂O, 1.3 g Na₂MoO₄×2H₂O, 0.2 g NaH₂PO₄ and 0.2 g Na₂SiO₇ is dissolved in 50 ml of deionised water and 3.7 g of 32% hydrochloric acid are added to the blue dispersion and stirred at room temperature for 15 minutes. The pH is set at 6.5 with a solution of sodium hydroxide (50% in water) and stirred for 1 hour at room temperature. The product is isolated by filtration, washed with deionised water and dried in an oven at 60° C. Yield: 3.6 g;

Thermographimetric analysis (TGA; heating rate: 10° C./min from 50° C. to 800° C.): Weight loss: 60% corresponding to the organic material.

### Example 9

### Silica/Victoria Blue/2-Mercapto-1-methyl imidazole

### a) Synthesis of Modified Silica Nanoparticles

(Example 8a is repeated)

### b) (A) Deprotonation of Victoria Pure Blue

(Example 8b is repeated)

### (B) Deprotonation of 2-Mercapto-1-methyl imidazole

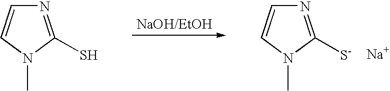

3.3 g (28.9 mmol) of 2-mercapto-1-methylimidazole are dissolved in 50 ml of ethanol and 28.9 ml of 1 M sodium hydroxide are added. The solution is kept for the next step.

### c) Grafting of the Dye and the 2-Mercapto-1-methylimidazole on the Particles Surface

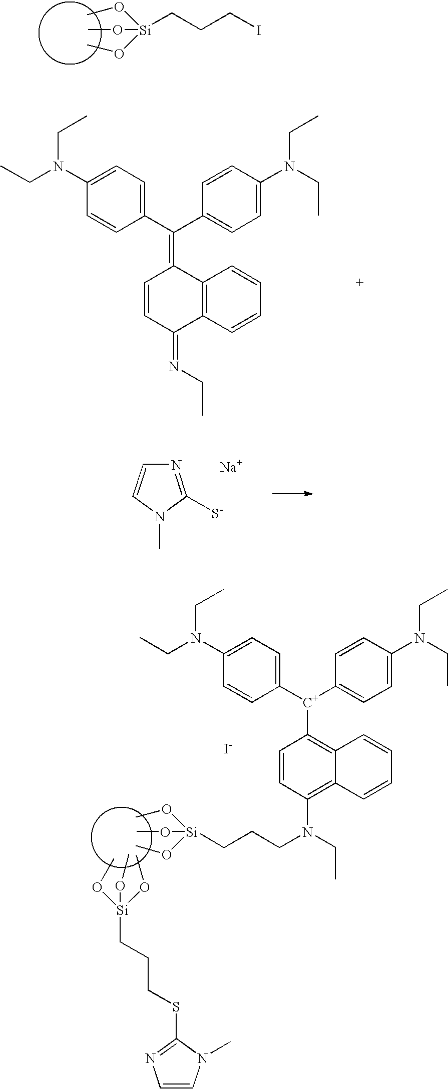

The solution of 2-mercapto-1-methylimidazole of step b(B) is added to the deprotonated dye dispersion of step b(A). The mixture is stirred vigorously at 50° C. The ethanolic particle dispersion of step a) is added and the mixture heated at 80° C. for 5 hours. The product is isolated by filtration and washed with deionised water. Yield: 65 g wet cake with a solid content of 40%. TGA Analysis (dried material) gave an organic content of 68%.

Anion exchange with POM: 7.34 g of wet cake (3.23 g dried material) is ground in a mill with 200 g beads (1-1.5 mm) and 70 g of a mixture ethanol/water (1:1 (v/v)) during 8 hours. A mixture of 3.1 g of Na₂WO₄×2H₂O, 1.3 g Na₂MoO₄×2H₂O, 0.2 g NaH₂PO₄ and 0.2 g Na₂SiO₇ is dissolved in 50 ml of deionised water and 3.7 g of 32% hydrochloric acid are added to the blue dispersion and stirred at room temperature for 15 minutes. The pH is set at 6.5 with a solution of sodium hydroxide (50% in water) and stirred for 1 hour at room temperature. The product is isolated by filtration, washed with deionised water and dried in an oven at 60° C. Yield: 3.6 g;

Thermographimetric analysis (TGA; heating rate: 10° C./min from 50° C. to 800° C.): Weight loss: 60% corresponding to the organic material.

While there have been shown, described and pointed out the features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention.

1. A color filter comprising a surface-modified nanoparticle wherein a cationic colorant is covalently attached to the surface of said nanoparticle.

2. A color filter according to claim 1, wherein the cationic colorant is
(i) a di(tri)-aryl(hetero)-dyestuff, and/or
(ii) a tri-aryl(hetero)-carbonium pigment.

3. A color filter according to claim 2, wherein the cationic colorant is a triarylmethane dye selected from the group consisting of Color Index names Acid Blue 1, Acid Blue 7, Acid Blue 9, Acid Blue 22, Acid Blue 93, Acid Blue 147, Acid Green 5, Acid Violet 19, Acid Violet 49, Basic Blue 7, Basic Blue 20, Basic Blue 26, Basic Green 4, Basic Red 9, Basic Violet 2, Basic Violet 3, Basic Violet 4, Basic Violet 14, Mordant Blue 1, Mordant Blue 3, Mordant Violet 39, Solvent Blue 3, Solvent Red 41, and Solvent Violet 9.

4. A color filter according to claim 2 wherein the cationic colorant is a triarylcarbonium pigment selected from the group consisting of Color Index names P. P. Blue 18, P. Blue 19, P. Blue 56, P. Blue 61, P. Violet 3, P. Violet 27, P. Violet 39, P. Blue 1, P. Blue 2, P. Blue 9, P. Blue 10, P. Blue 14, P. Blue 62, P. Green 1, P. Green 4, P. Green 45, P. Red 81, P. Red 81:1, P. Red 81:x, P. Red 81:y, P. Red 81:2, P. Red 81:3, P. Red 81:4, P. Red 169, P. Violet 1, P. Violet 1:x, and P. Violet 2.

5. A color filter according to claim 1, wherein further a light stabilizer, is covalently attached to the surface of said nanoparticle.

6. A color filter according to claim 5, wherein said light stabilizer is selected from the group consisting of hindered amine light stabilizer (HALS), benzophenones, benzotriazoles, and hydroxyphenyl triazines.

7. A color filter according to claim 6 wherein said light stabilizer is a UV absorber moiety selected from the group consisting of 2-[2-hydroxy-3,5-di-(alpha,alpha-dimethylbenzyl)phenyl]-2H-benzotriazole, 2-(2-hydroxy-3,5-di-tert-amylphenyl)-2H-benzotriazole, 2-[2-hydroxy-3-tert-butyl-5-(omega-hydroxy-octa(ethyleneoxy)carbonyl)ethylphenyl]-2H-benzotriazole, 2-[2-hydroxy-3-tert-butyl-5-(2-octyloxycarbonylethyl)phenyl]-2H-benzotriazole, 4,4′-dioctyloxyoxanilide, 2,2′-dioctyloxy-5,5′-di-tert-butyloxanilide, 2,2′-didodecyloxy-5,5′-di-tert-butyloxanilide, 2-ethoxy-2′ethyloxanilide, 2,6-bis(2,4-dimethylphenyl)-4-(2-hydroxy-4-octyloxyphenyl-s-triazine, 2,6-bis(2,4-dimethylphenyl)-4-(2,4-dihydroxyphenyl)-s-triazine, 2,4-bis(2,4-dihydroxyphenyl)-6-(4-chlorophenyl)-s-triazine, 2,6-bis(2,4-dimethylphenyl)-4-[2-hydroxy-4-(2-hydroxy-3-dodecyloxypropanoxy)phenyl]-s-triazine, and 2,2′-dihydroxy-4,4′-dimethoxybenzophenone.

8. A color filter according to claim 1, wherein further a dispersant is covalently attached to the surface of said nanoparticle.

9. A color filter according to claim 8 wherein the dispersant is selected from the group consisting of anionic surfactants and cationic surfactants.

10. A color filter according to claim 1, wherein the surface-modified nanoparticle is treated with an oxyacid compound or hydrogen oxyacid compound.

11. A color filter according to claim 10, wherein the anion species of the oxyacid compound or said hydrogen oxyacid compound is a polyvalent oxyacid anion.

12. A color filter according to claim 1, wherein the nanoparticle is an organophilically modified natural or synthetic phyllosilicate or a mixture of organophilically modified natural or synthetic phyllosilicates.

13. A polymerizable mixture for making color filters comprising
a) a surface-modified nanoparticle wherein a cationic colorant is covalently attached to the surface of said nanoparticle and
b) at least one ethylenically unsaturated polymerizable compound.

14. A surface-modified nanoparticle wherein
(i) a cationic colorant of a di(tri)-aryl(hetero)-dyestuff, and further a dispersant are covalently attached to the surface of said nanoparticles; or
(ii) a tri-aryl(hetero)-carbonium pigment is covalently attached to the surface of said nanoparticle.

15. (canceled)

16. A color filter according to claim 2, wherein the cationic colorant is a di(tri)-aryl(hetero)-dyestuff preferably selected from the group consisting of triarylmethane, eteroaryldiarylmethane, diheteroarylarylmethane, xanthene and thioxanthene dyes.

17. A color filter according to claim 5, wherein the light stabilizer is covalently attached to the surface of said nanoparticle is a UV absorber.

18. A color filter according to claim 9 wherein the dispersant is
an anionic surfactant selected from the group consisting of water-soluble alkali metal salts of sulfate esters or sulfonates containing aliphatic hydrocarbon radicals of 8 to 22 carbon atoms, sodium or potassium salts of C₈-C₂₂alkylbenzene sulfonic acids and alkali metal salts of (hetero)cyclic thiols,
and/or
a cationic surfactant selected from the group consisting of fatty amines condensed with ethylene oxide, long chain primary amines and quaternary ammonium compounds in which there is a quaternary nitrogen atom directly linked to a C₁₀-C₂₂alkyl or C₈-C₂₂alkyl aryl radical, three valences of the nitrogen atom being also directly linked to other carbon atoms of same or different C₁-C₆alkyl radicals or two of them form with the quaternary nitrogen atom a (hetero)cycle of 1 to 10 carbon atoms.

19. A color filter according to claim 11, wherein the anion species of the oxyacid compound or said hydrogen oxyacid compound is a polyvalent oxyacid anion selected from the group consisting of phosphate, tungstate, molybdate, silicate, germanate and vanadate.

20. A surface-modified nanoparticle according to claim 14 wherein the cationic colorant is a di(tri)-aryl(hetero)-dyestuff selected from the group consisting of triarylmethane, heteroaryldiarylmethane, diheteroarylarylmethane, xanthene and thioxanthene dyes.
